(19) United States
(12) Patent Application Publication
(10) Pub. No.: US 2022/0248101 A1
(43) Pub. Date: Aug. 4, 2022

(54) USER INTERFACES FOR INDICATING AND/OR CONTROLLING CONTENT ITEM PLAYBACK FORMATS

(71) Applicant: Apple Inc., Cupertino, CA (US)

(72) Inventors: Erik Lindholm, San Francisco, CA (US); Christopher D. Carvey, San Jose, CA (US); Thomas Alsina, Saratoga, CA (US)

(21) Appl. No.: 17/584,281

(22) Filed: Jan. 25, 2022

Related U.S. Application Data
(60) Provisional application No. 63/143,753, filed on Jan. 29, 2021.

(51) Int. Cl. H04N 21/472; H04N 21/4402; H04N 21/482

(52) U.S. Cl. CPC H04N 21/47217; H04N 21/482; H04N 21/47202; H04N 21/44029

(57) ABSTRACT

In some embodiments, an electronic device facilitates selection of a format for the playback of content. In some embodiments, while displaying, via a display generation component, a content playback user interface for a first content item that is playing at the electronic device, wherein the electronic device is playing the first content item in a first format, in accordance with a determination that the first content item is available in a second format, different from the first format, and that a currently-active output device for playing the first content item is compatible with the second format, the electronic device displays, in the content playback user interface, a selectable option that is selectable to initiate a process to switch from playing the first content item in the first format to playing the first content item in the second format.

### CROSS-REFERENCE TO RELATED APPLICATIONS

This application claims the benefit of U.S. Provisional Application No. 63/143,753, filed Jan. 29, 2021, the content of which is incorporated herein by reference in its entirety for all purposes.

### FIELD OF THE DISCLOSURE

This specification relates generally to electronic devices that display user interfaces for indicating and/or controlling the format in which content items are being played by the electronic devices.

### BACKGROUND

User interaction with electronic devices has increased significantly in recent years. These devices can be devices such as computers, tablet computers, televisions, multimedia devices, mobile devices, and the like.

In some circumstances, users wish to view information about the format in which a content item is being played by an electronic device and/or wish to control the format in which the content item is being played by an electronic device. An electronic device can provide a user with user interfaces for performing such actions.

### SUMMARY

Some embodiments described in this disclosure are directed to user interfaces for facilitating selection of a format for the playback of content that is available in multiple formats (e.g., stereo sound, surround sound, lossless audio, high-resolution lossless audio). Enhancing these interactions improves the user's experience with the device and decreases user interaction time, which is particularly important where input devices are battery-operated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6DD illustrate exemplary ways in which an electronic device facilitates selection of a format for the playback of content in accordance with some embodiments.

FIG. 7 is a flow diagram illustrating a method for facilitating selection of a format for the playback of content in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient user interfaces and mechanisms for user interaction for viewing information about and/or controlling the format in which content items are being played back by electronic devices. In some implementations, an electronic device displays, in a content playback user interface, a selectable indication for switching playback of the currently-playing content item from a first format (e.g., stereo sound) to a second format (e.g., surround or spatial sound). In some implementations, the electronic device displays the selectable indication only if the currently-active output device (e.g., headphones, speakers, etc.) via which the electronic device is playing the currently-playing content item is compatible with, or capable of reproducing the content item in, the second format. In some implementations, the electronic device displays an indication in the content playback user interface if the output signal path (e.g., including the connection between the electronic device and the output device, such as a Bluetooth connection) is unable to reproduce the currently-playing content item in the currently-selected playback format. Such techniques can provide for efficient manners of viewing information about the currently-playing format and/or changing the currently-playing format, and can thus reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, Calif. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

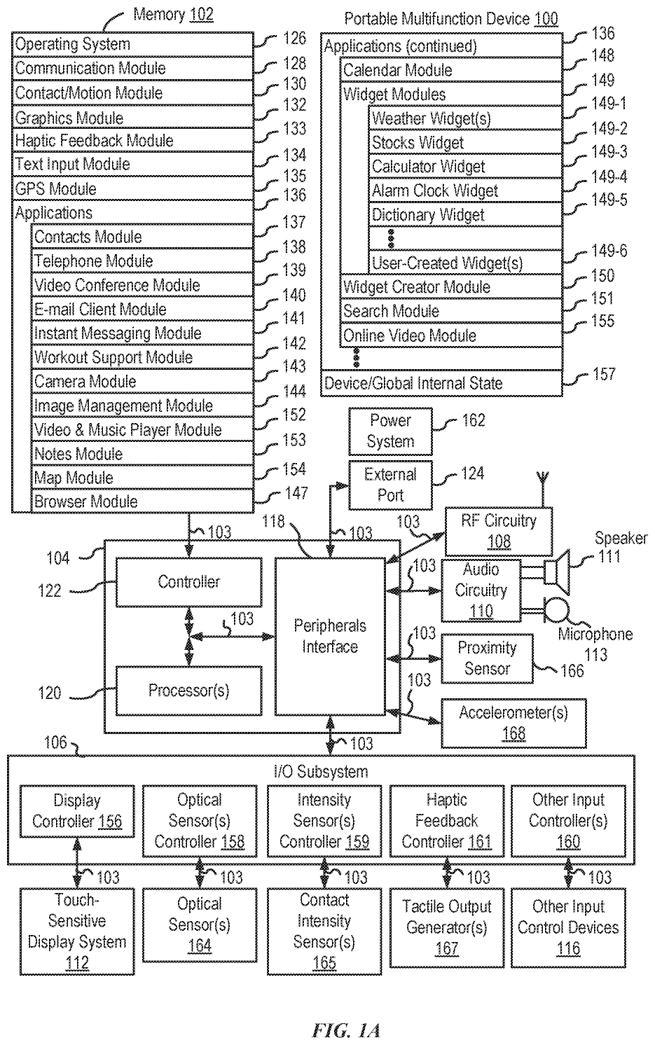

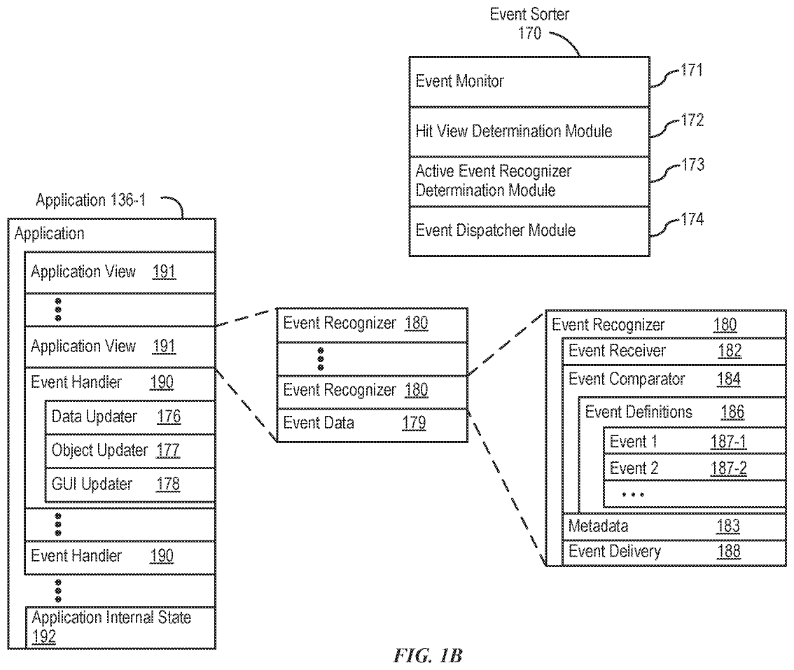

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

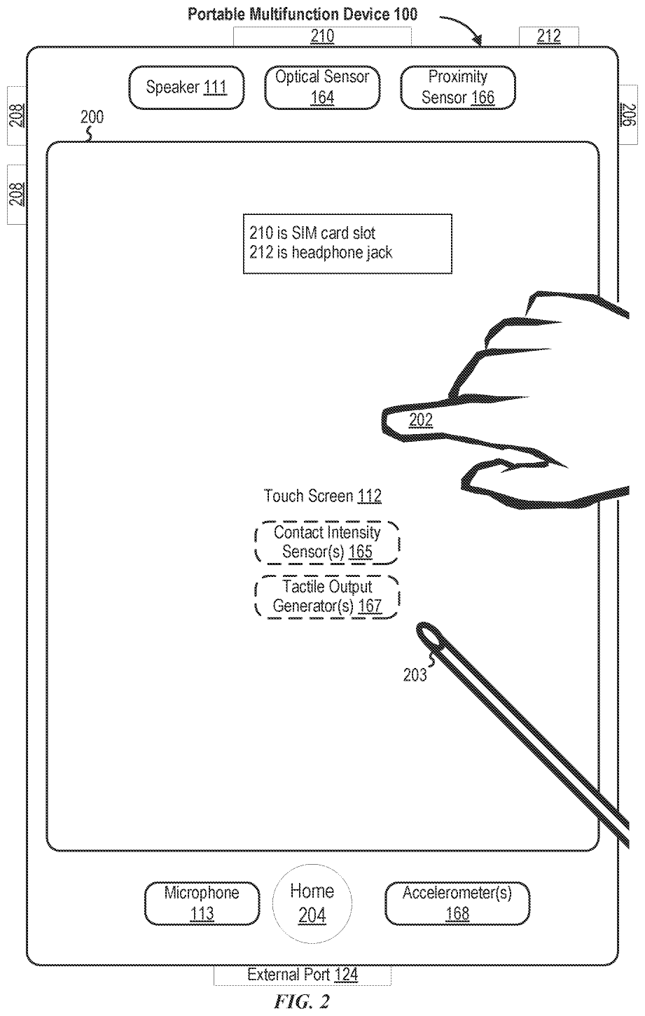

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures) as input. In some embodiments, the one or more input devices are integrated with the computer system. In some embodiments, the one or more input devices are separate from the computer system.

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, Calif.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

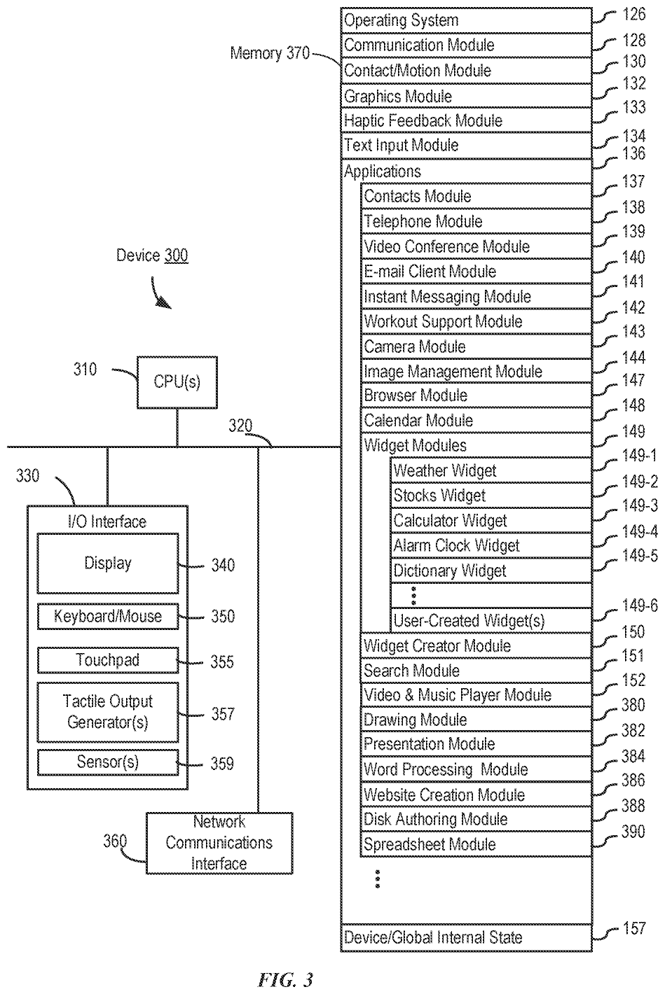

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

In some embodiments, stylus 203 is an active device and includes one or more electronic circuitry. For example, stylus 203 includes one or more sensors, and one or more communication circuitry (such as communication module 128 and/or RF circuitry 108). In some embodiments, stylus 203 includes one or more processors and power systems (e.g., similar to power system 162). In some embodiments, stylus 203 includes an accelerometer (such as accelerometer 168), magnetometer, and/or gyroscope that is able to determine the position, angle, location, and/or other physical characteristics of stylus 203 (e.g., such as whether the stylus is placed down, angled toward or away from a device, and/or near or far from a device). In some embodiments, stylus 203 is in communication with an electronic device (e.g., via communication circuitry, over a wireless communication protocol such as Bluetooth) and transmits sensor data to the electronic device. In some embodiments, stylus 203 is able to determine (e.g., via the accelerometer or other sensors) whether the user is holding the device. In some embodiments, stylus 203 can accept tap inputs (e.g., single tap or double tap) on stylus 203 (e.g., received by the accelerometer or other sensors) from the user and interpret the input as a command or request to perform a function or change to a different input mode.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

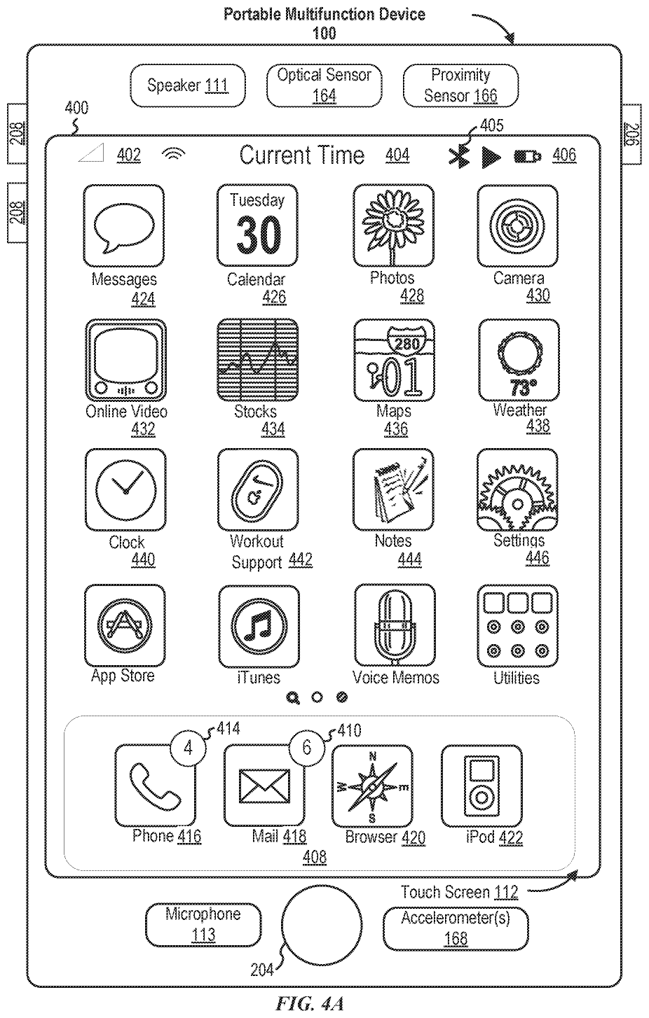

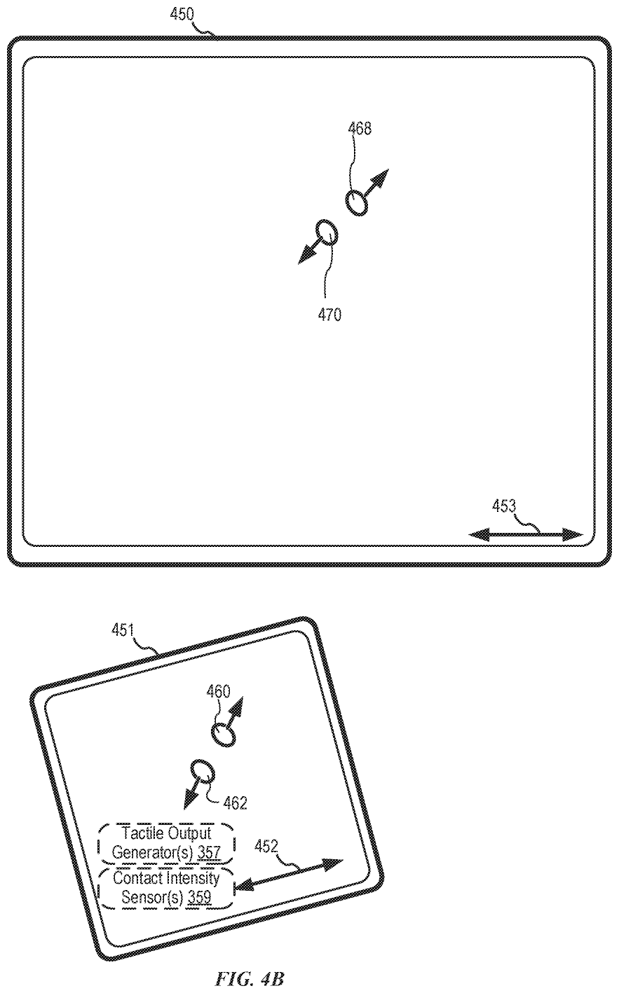

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

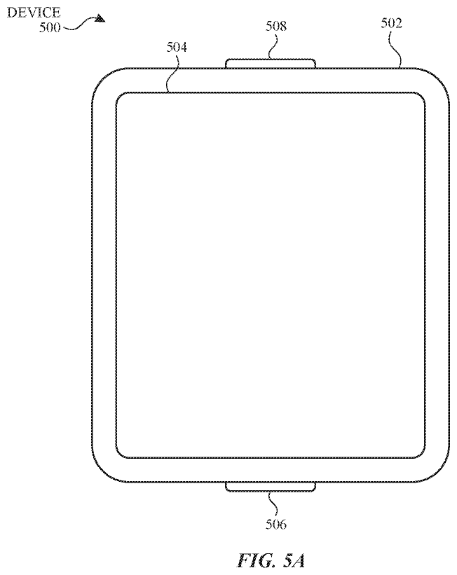

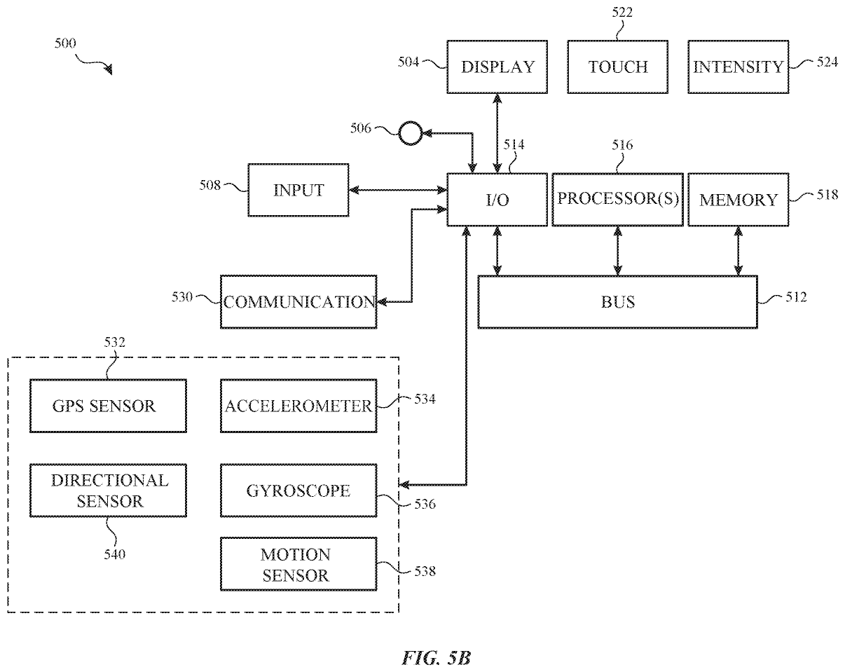

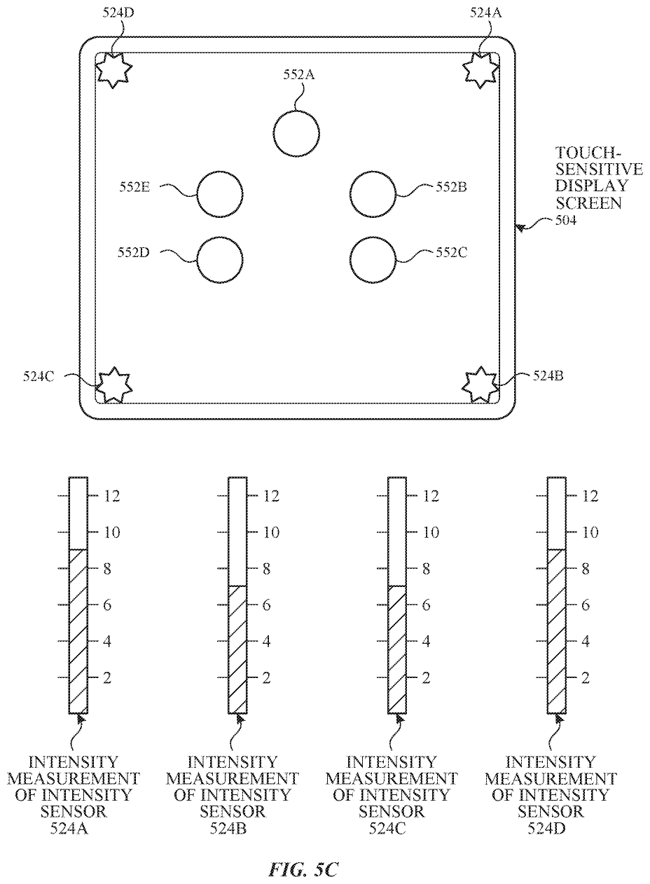

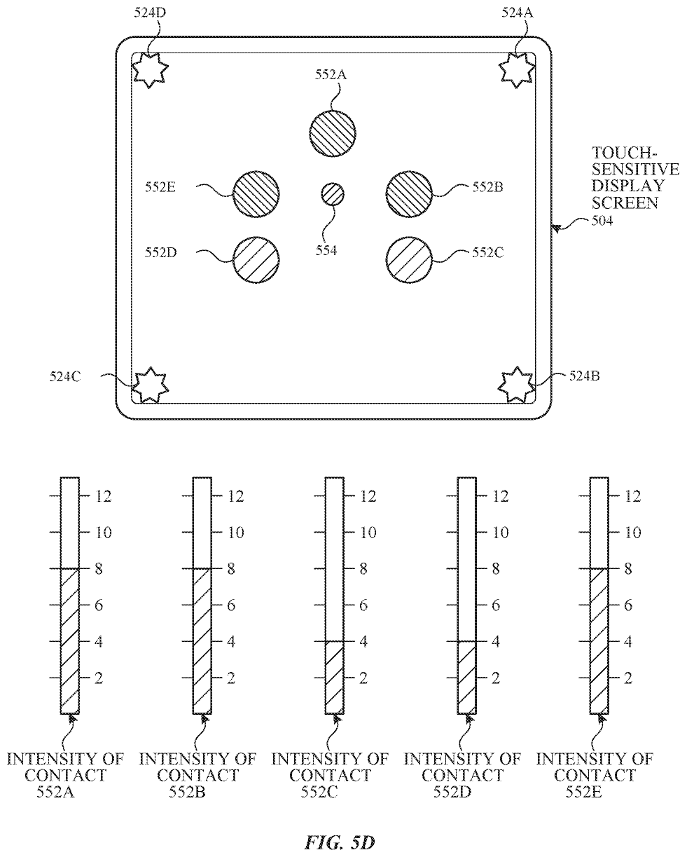

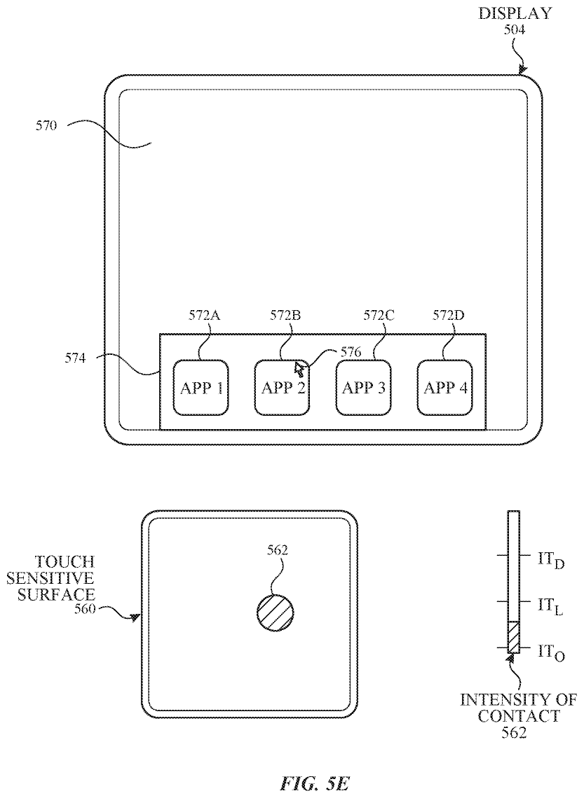

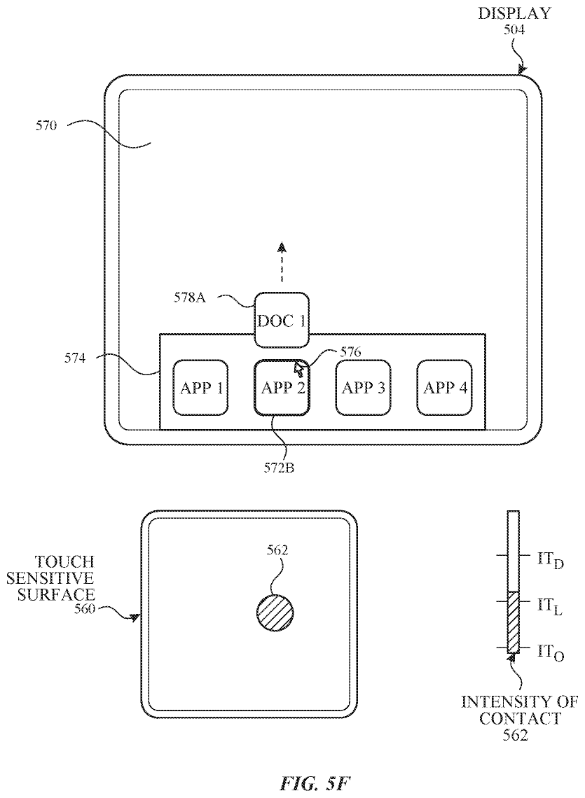

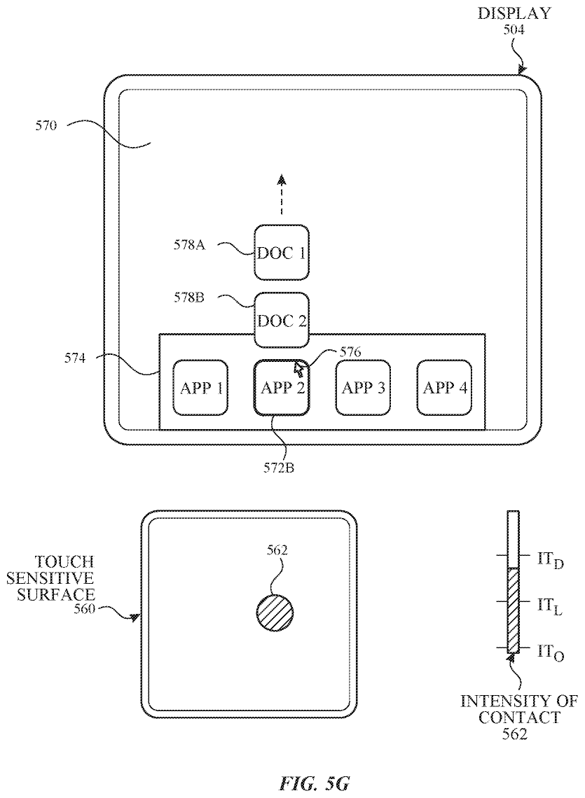

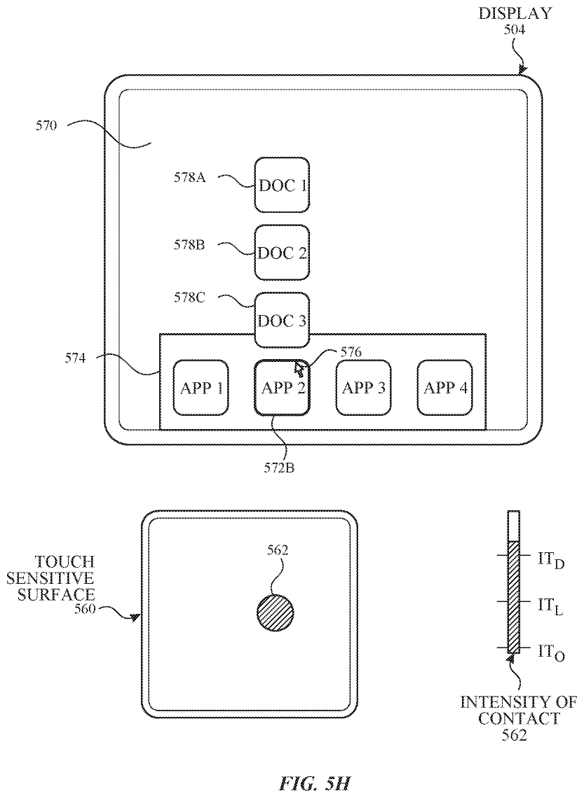

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

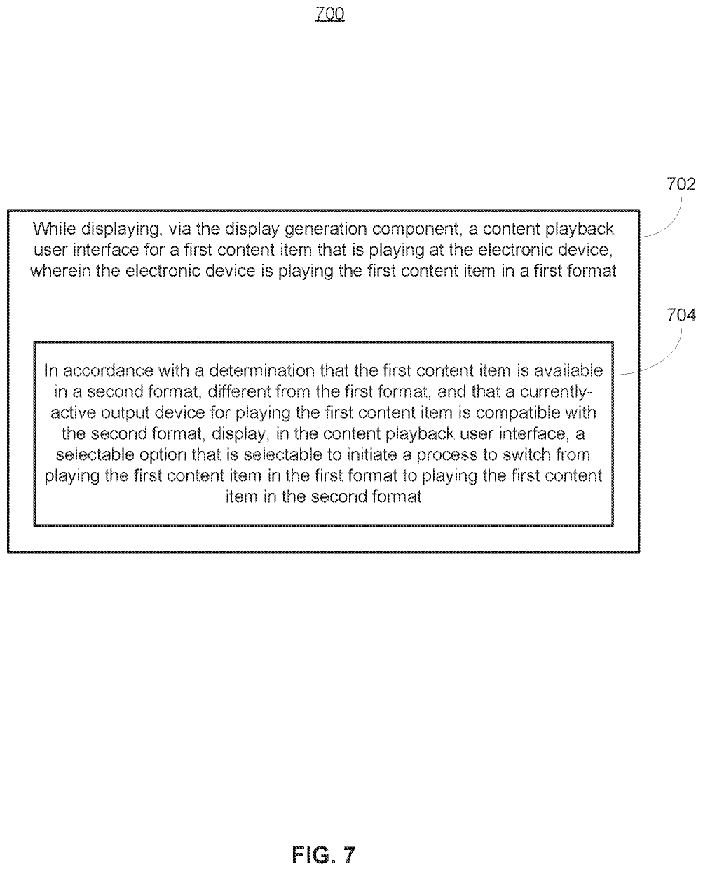

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 700 (FIG. 7). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “ITS”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces and Associated Processes

### User Interfaces for Indicating and/or Controlling the Playback Format of Content

Users interact with electronic devices in many different manners, including interacting with applications that display and/or allow for the playing of content (e.g., songs, videos, movies, television shows, etc.). In some embodiments, an electronic device displays a content playback user interface while playing content. In some circumstances, the content is available for playback in more than one format (e.g., mono sound, stereo sound, surround sound, lossy format, lossless format, high-resolution lossless format, etc.). The embodiments described below provide ways in which an electronic device provides efficient user interfaces for displaying indications of format(s) in which the content is available and/or playing, and/or ways in which an electronic device provides efficient user interfaces for selecting the format in which to play the content. For example, in some circumstances, the electronic device displays a visual indication in the content playback user interface based on the currently-playing format of the currently-playing content item, and/or displays a selectable option in the content playback user interface that is selectable to switch the format of the currently playing content. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

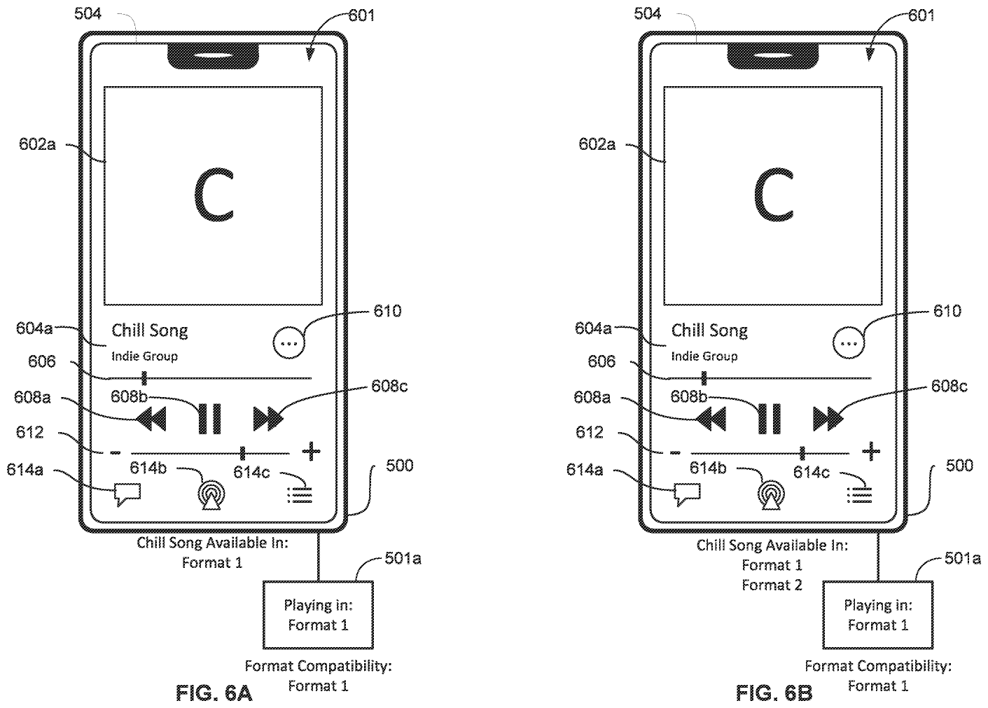

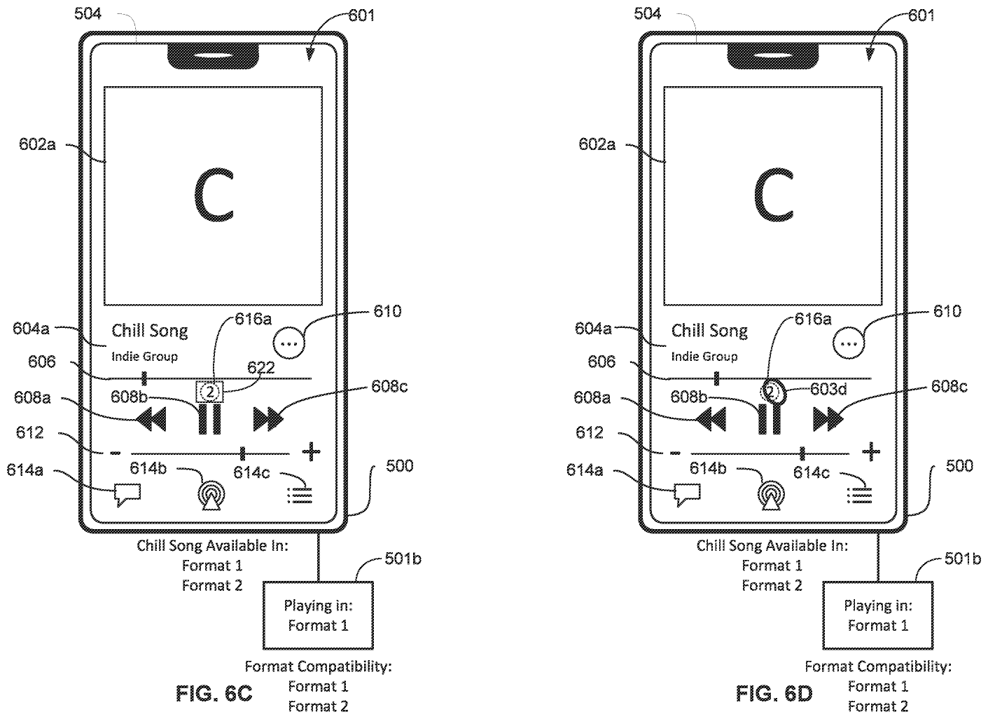

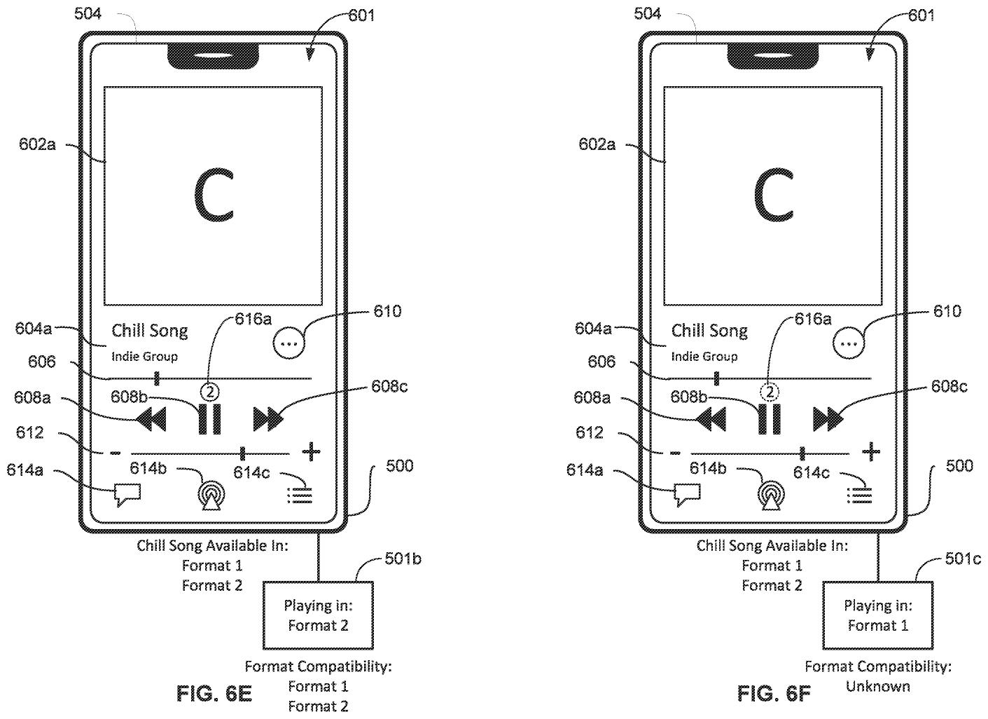

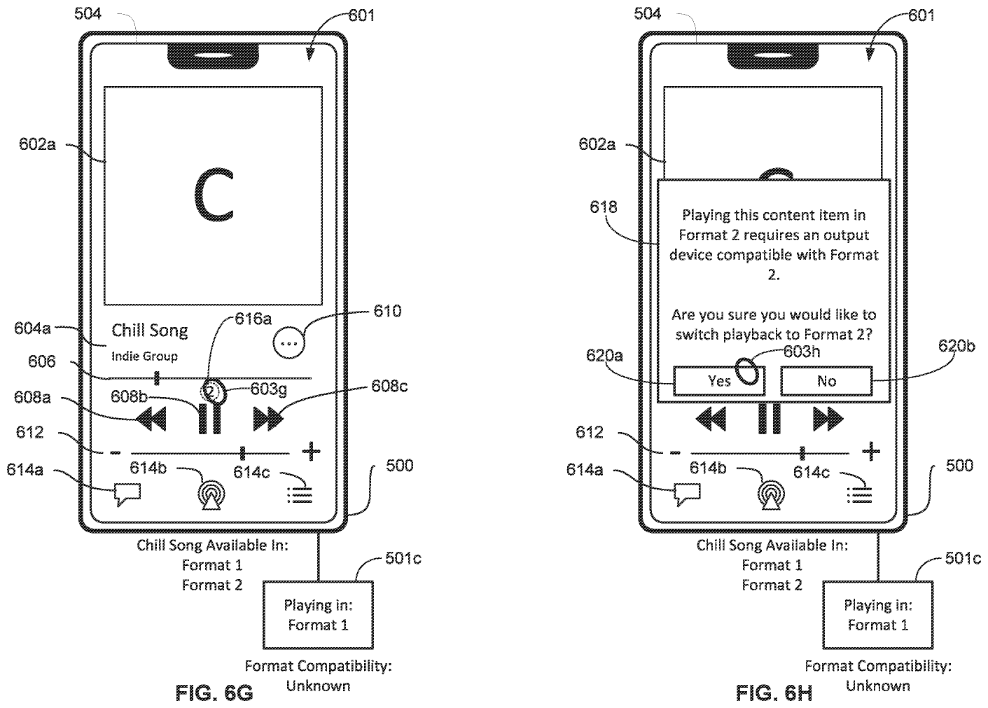

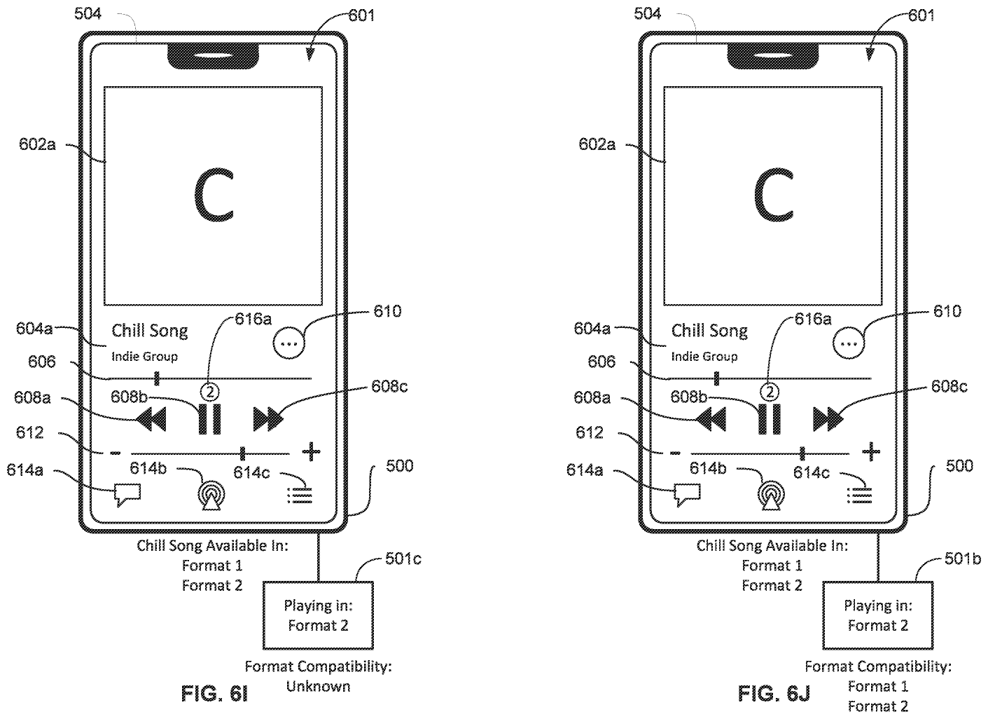

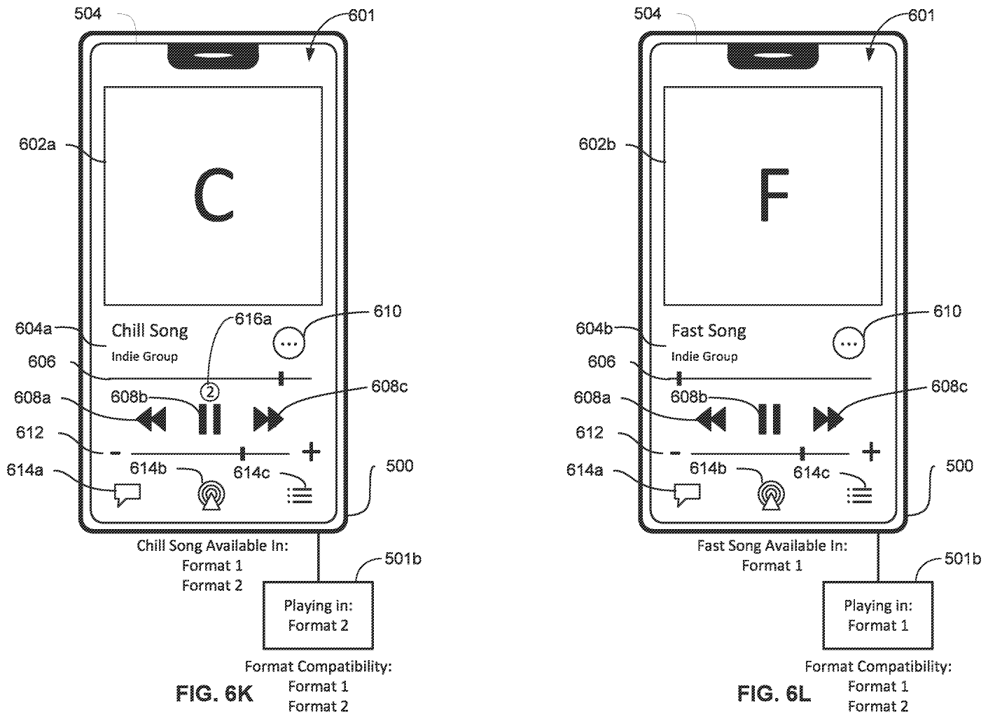

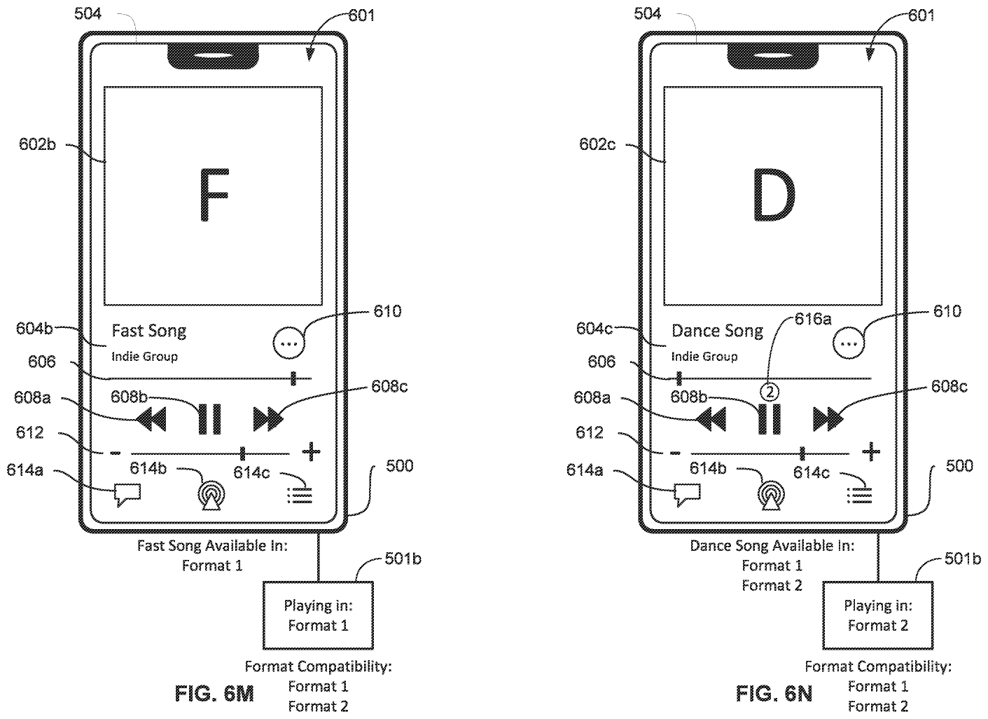

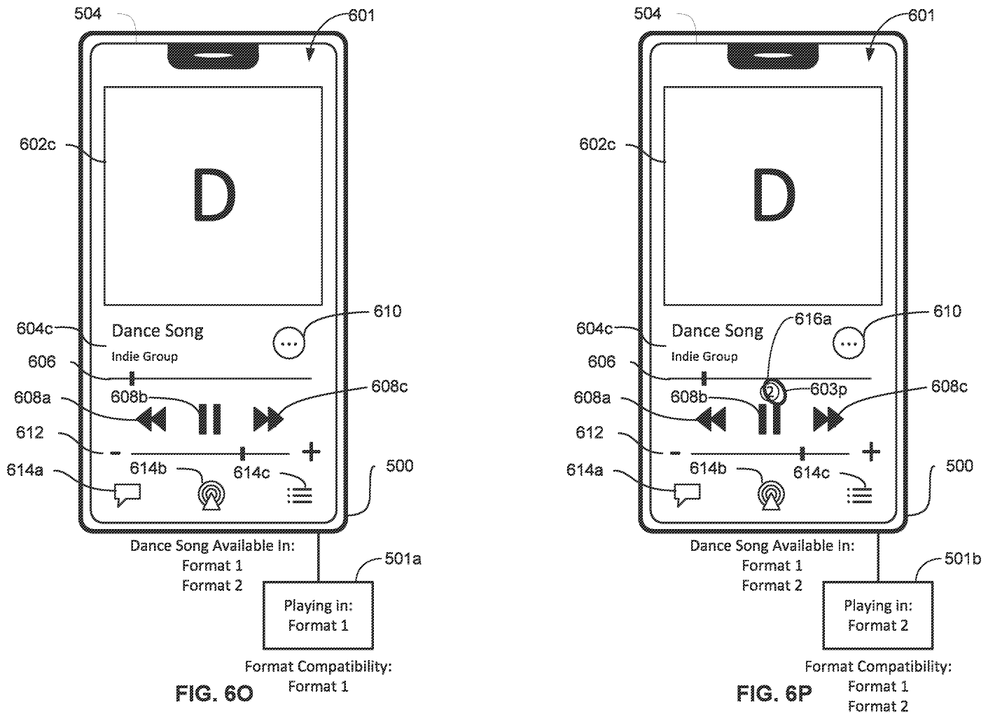

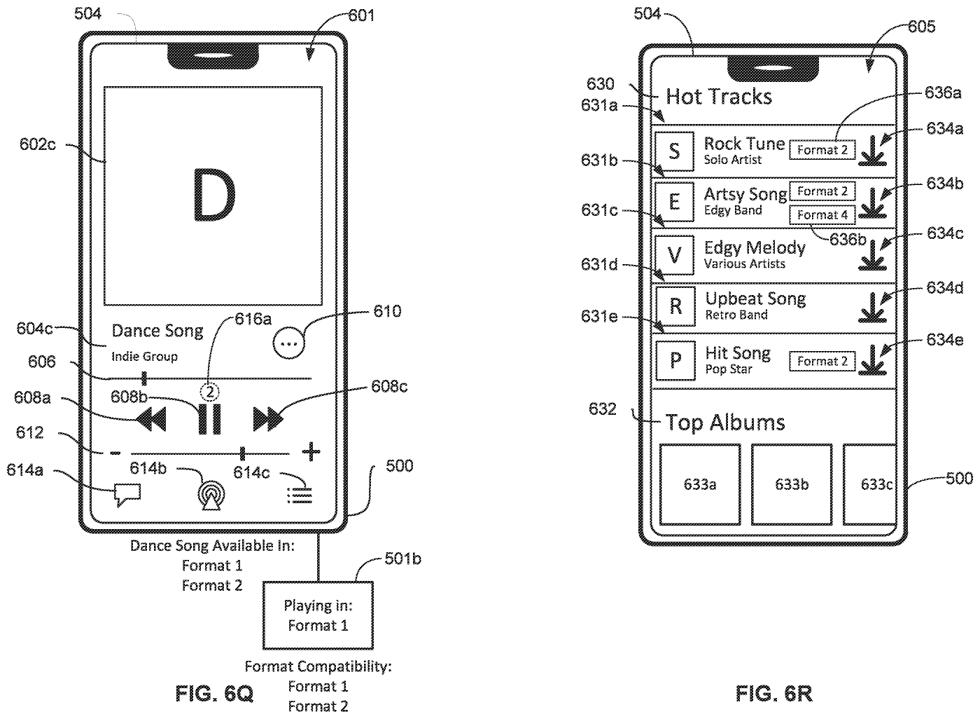

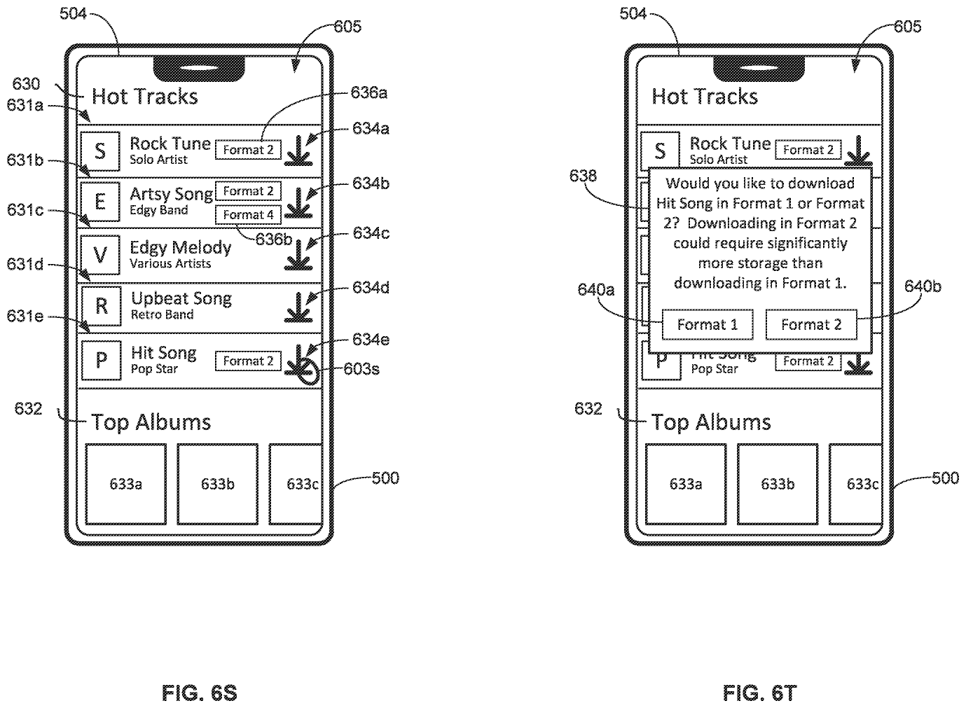

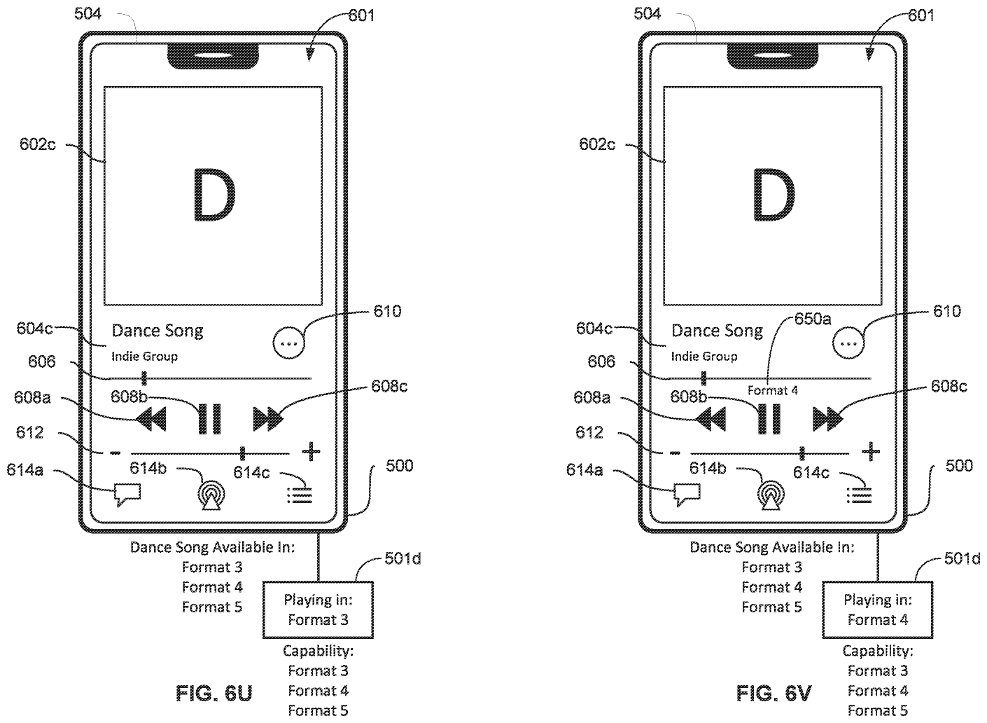

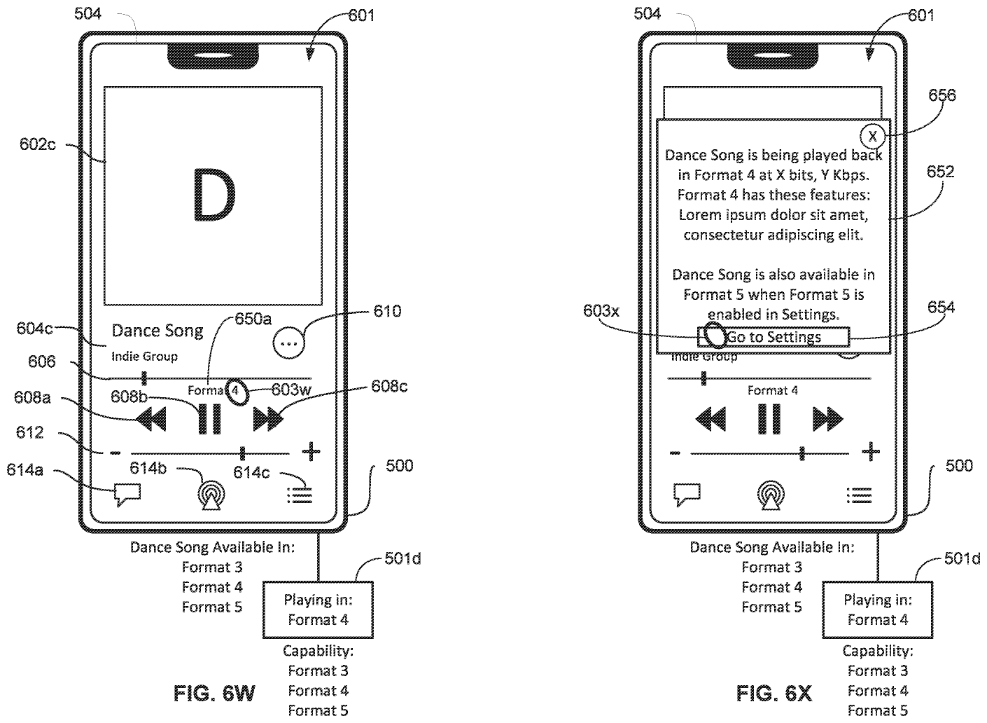

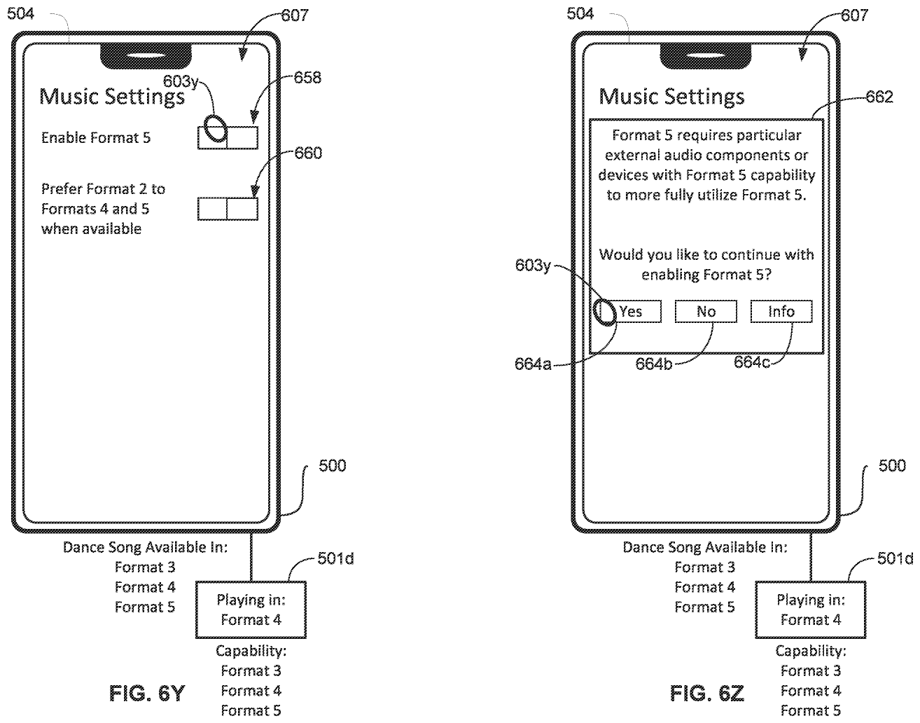

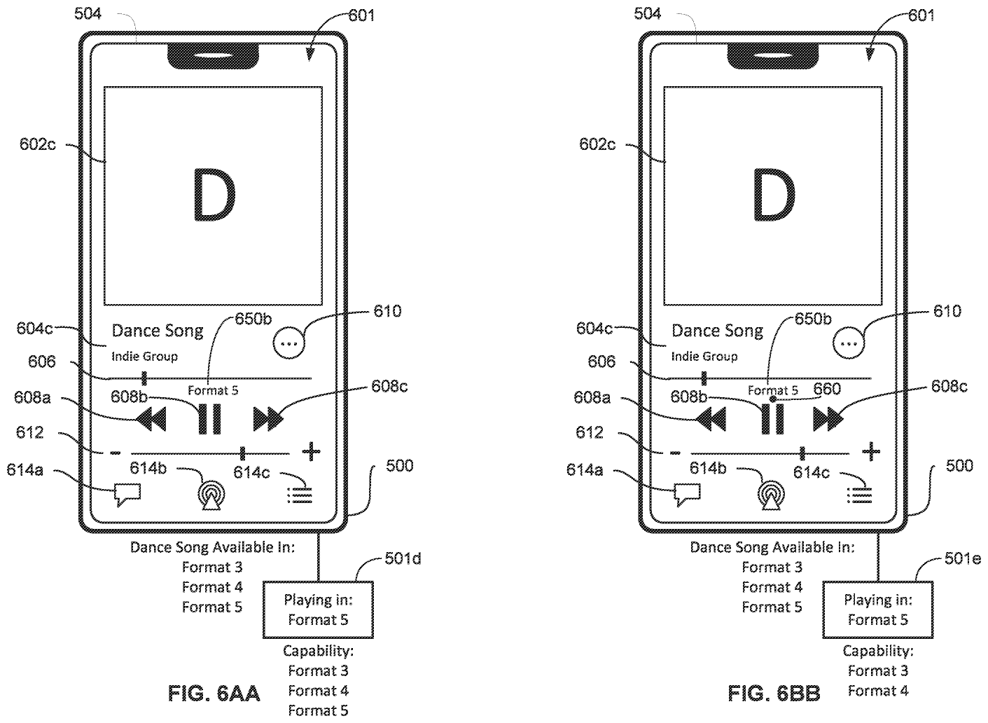

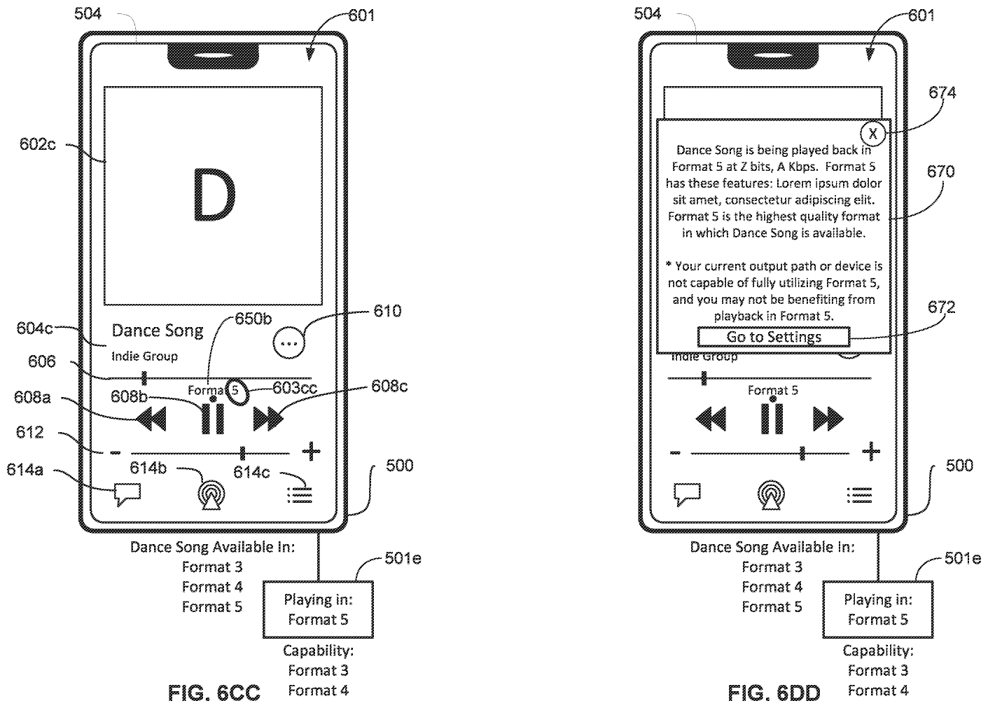

FIGS. 6A-6DD illustrate exemplary ways in which an electronic device facilitates selection of a format for the playback of content. The embodiments in these figures are used to illustrate the processes described below, including the processes described with reference to FIG. 7. Although FIGS. 6A-6DD illustrate various examples of ways an electronic device is able to perform the processes described below with reference to FIG. 7, it should be understood that these examples are not meant to be limiting, and the electronic device is able to perform one or more processes described below with reference to FIG. 7 in ways not expressly described with reference to FIGS. 6A-6DD.

FIG. 6A illustrates an exemplary device 500 displaying a user interface 601. In some embodiments, the user interface 601 is displayed via a display generation component (e.g., touch screen 504). In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device. As shown in FIG. 6A, the electronic device 500 is displaying a content playback user interface 601 on touch screen 504 while playing the Chill Song content item. In FIG. 6A, the user interface 601 includes artwork or imagery 602a associated with Chill Song, the name of Chill Song and/or the artist associated with Chill Song 604a (e.g., “Indie Group”), a scrubber bar 606 that is interactable to change the current playback position within Chill Song, playback controls 608 (e.g., including rewind control 608a, pause control 608b, fast forward control 608c) that are interactable to control playback of Chill Song, a volume control 612 that is interactable to change the volume of the playback of Chill Song (e.g., either the volume of the internal speakers of device 500, or the volume of external speakers of an output device via which device 500 is playing Chill Song), a selectable option 614a that is selectable to display lyrics for Chill Song, a selectable option 614b that is selectable to change the output device via which device 500 is playing Chill Song, a selectable option 614c that is selectable to display other content items in a currently-playing sequence of content items (e.g., other songs in the currently-playing playlist or album), and a selectable option 610 that is selectable to display a menu including menu items that are selectable to perform additional operations with respect to Chill Song (e.g., share Chill Song with another electronic device, add Chill Song to a library of the user of device 500, etc.).

As previously mentioned, in some embodiments, device 500 can play a content item via different output devices. For example, device 500 is optionally able to play a content item via its internal speakers, via external headphones, via an external television or smart speaker, etc. In some embodiments, the currently-active output device can be selected via selection of selectable option 614b in user interface 601. Further, in some embodiments, a given content item is available for playback (e.g., via a content delivery service from which device 500 accesses content) on device 500 in multiple formats, such as being available in mono audio, in stereo audio, in surround audio, in spatial audio, in a lossy audio format, in a lossless audio format, in a high-resolution lossless audio format, etc. Therefore, in some embodiments, device 500 displays information and/or selectable options in user interface 601 for facilitating switching between different formats in which a given content item (e.g., the currently-playing content item) is available, as will be described below. However, not all output devices—whether internal to device 500, such as internal speakers, or external to device 500, such as external Bluetooth earbuds—may be compatible with all formats in which the content items are available. Therefore, in some embodiments, the display of the information and/or selectable options in user interface 601 for facilitating switching between different formats in which a given content item (e.g., the currently-playing content item) is available is based on compatibility and/or capability information of the output device, as will be described below.

For example, in FIG. 6A, Chill Song is only available in a first format (“Format 1”), as indicated by the text under device 500 in FIG. 6A. Further, device 500 is currently playing Chill Song via output device 501a (e.g., internal speakers of device 500 or external speakers/headphones) in Format 1, with which output device 501a is compatible, as indicated by the text under output device 501a in FIG. 6A. In some embodiments, Format 1 is a stereo or mono audio format. Because Format 1 is a stereo or mono audio format, and because output device 501a is compatible with Format 1, device 500 optionally plays Chill Song via output device 501a in Format 1, as indicated by the text within the representation of output device 501a in FIG. 6A. Further, in FIG. 6A, device 500 does not display an indication of Format 1 in user interface 601.

In FIG. 6B, Chill Song is available in both Format 1 and Format 2. Format 2 is optionally a higher quality format and/or a format that requires more capability from the output device 501a and/or the output signal path including and between device 500 and output device 501a. For example, Format 2 is a surround sound or spatial audio format. In some embodiments, the spatial audio format is one in which headphones connected to the device, for example, generate the audio of Chill Song such that the source of the audio appears to be anchored to the position of device 500, even if the orientation and/or position of the headphones changes relative to device 500 (e.g., due to the user turning their head and/or due to movement of device 500). In FIG. 6B, however, output device 501a is only compatible with Format 1, and is not compatible with Format 2; therefore, device 500 is playing Chill Song via output device 501a in Format 1, and device 500 does not display an indication of Format 1 or Format 2 in user interface 601.

In FIG. 6C, Chill Song is available in both Format 1 and Format 2, and the currently-active output device of device 500 has been changed to output device 501b (e.g., via selection of option 614b). Output device 501b is optionally compatible with both Format 1 and Format 2. Because Chill Song is available in Format 2, and output device 501b is compatible with Format 2, device 500 displays selectable option 616a in user interface 601. Selectable option 616a optionally indicates the availability of Format 2 for Chill Song (e.g., by the “2” included in selectable option 616a). Selectable option 616a is optionally selectable to cause device 500 to switch to playing Chill Song in Format 2 instead of Format 1. In FIG. 6C, device 500 is playing Chill Song via output device 501b in Format 1, because device 500 has not yet detected selection of selectable option 616a. Further, in some embodiments, if the playing of Chill Song shown in FIG. 6C is the first time (or less than a threshold number of times, such as 3, 5, 10) that device 500 has played a content item that is available in Format 2, device 500 optionally visually emphasizes (e.g., highlights) selectable option 616a (e.g., indicated by indication 622 in FIG. 6C) to visually indicate the existence of selectable option 616a for transitioning to playing back Chill Song in Format 2. If the playing of Chill Song shown in FIG. 6C is not the first time (or less than the threshold number of times) that device 500 has played a content item that is available in Format 2, device 500 optionally does not visually emphasize selectable option 616a.

In FIG. 6D, device 500 detects selection of selectable option 616a (e.g., via contact 603d). In response, device 500 transitions to playing Chill Song in Format 2 via output device 501b, as shown in FIG. 6E. In some embodiments, device 500 continues playback of Chill Song in Format 2 from its current playback position (e.g., without restarting Chill Song from its beginning) in response to selection of selectable option 616a. Further, in some embodiments, selectable option 616a becomes selected or activated in response to the input detected in FIG. 6D; therefore, device 500 optionally changes the visual appearance of selectable option 616a to indicate that playback of Chill Song in Format 2 is now activated (e.g., device 500 displays selectable option 616a in a greyed out manner in FIGS. 6C-6D, and displays selectable option 616a in color in FIG. 6E), as shown in FIG. 6E where the boundary of selectable option 616a is illustrated as no longer dashed as it was in FIGS. 6C-6D.

In FIG. 6F, Chill Song is available in both Format 1 and Format 2, and the currently-active output device of device 500 has been changed to output device 501c (e.g., via selection of option 614b). Device 500 optionally does not have access to information about the compatibility of output device 501c; for example, because output device 501c does not transmit, to device 500, information identifying the formats with which output device 501c is compatible. Further, in FIG. 6F, device 500 is playing Chill Song in Format 1 via output device 501c. In some embodiments, when device 500 does not have information that indicates whether output device 501c is compatible with Format 2, device 500 does not display selectable option 616a in user interface 601. However, in some embodiments, device 500 does display selectable option 616a in user interface 601 (e.g., because Chill Song is available in Format 2, and output device 501c may be compatible with Format 2), as shown in FIG. 6F.

In FIG. 6G, device 500 detects selection of selectable option 616a (e.g., via contact 603g). In response, device 500 displays user interface 618 (e.g., overlaid on user interface 601), as shown in FIG. 6H. Because the compatibility of output device 501c with Format 2 is unknown, device 500 displays user interface 618 that indicates that playback of Chill Song in Format 2 requires an output device that is compatible with Format 2, and that asks for confirmation that the transition to playing Chill Song in Format 2 be completed. User interface 618 optionally includes selectable option 620a that is selectable to complete/perform the transition to Format 2, and selectable option 620b that is selectable to cancel the transition to Format 2 (e.g., and continue playing Chill Song in Format 1). In FIG. 6H, device 500 detects selection of selectable option 620a (e.g., via contact 603h).

In response, device 500 transitions to playing Chill Song in Format 2 via output device 501c, as shown in FIG. 6I. In some embodiments, even though device 500 does not have information about whether output device 501c is compatible with Format 2, device 500 is able to transmit, to output device 501c, output signals for reproducing Chill Song in Format 2. Output device 501c may or may not actually output Chill Song in Format 2 in FIG. 6I, depending on whether output device 501c actually is or actually is not, respectively, compatible with Format 2.

In some embodiments, device 500 is able to automatically (e.g., without user input) switch between playing content in Format 1 or Format 2 depending on whether the content is or is not available in Format 2. For example, in FIG. 6J, device 500 is playing Chill Song via output device 501b in Format 2. Output device 501b is compatible with Format 2, and device 500 displays selectable option 616a in the selected or activated state in user interface 601, as previously described. In FIG. 6K, device 500 has continued to play Chill Song in Format 2 via output device 501b, and the current playback position has advanced towards the end of Chill Song, as indicated by scrubber bar 606.

In FIG. 6L, device 500 has switched to playing Fast Song via output device 501b (e.g., due to reaching the end of Chill Song or in response to detecting an input to skip to the next song in a sequence of songs—such as a playlist or album—that is currently being played). Fast Song is available in Format 1, but is not available in Format 2. Therefore, device 500 has automatically switched to playing Fast Song in Format 1, and is not displaying selectable option 616a in user interface 601, as shown in FIG. 6L. In FIG. 6M, device 500 has continued to play Fast Song in Format 1 via output device 501b, and the current playback position has advanced towards the end of Fast Song, as indicated by scrubber bar 606.

In FIG. 6N, device 500 has switched to playing Dance Song via output device 501b (e.g., due to reaching the end of Fast Song or in response to detecting an input to skip to the next song in a sequence of songs—such as a playlist or album—that is currently being played). Dance song is available in Format 1 and in Format 2. Because device 500 last played a content item that was available in Format 2 in Format 2, device 500 has automatically switched to playing Dance Song in Format 2, and is again displaying selectable option 616a in the selected or activated state in user interface 601, as shown in FIG. 6N. Therefore, as shown in FIGS. 6J to 6N, device 500 automatically switches between playing content in Format 1 or Format 2 depending on whether the currently-playing content item is available in Format 1 and/or Format 2.

In a similar way, in some embodiments, device 500 automatically switches between playing content in Format 1 or Format 2 depending on whether the currently-active output device is compatible with Format 1 and/or Format 2. For example, in FIG. 6N, device 500 is playing Dance song, which is available in Format 1 and Format 2, via output device 501b in Format 2—because output device 501b is compatible with Format 2 (e.g., and Format 1), and playback in Format 2 has been enabled via selection of selectable option 616a. In FIG. 6O, the currently-active output device has changed to output device 501a (e.g., via selection of selectable option 614b), which is compatible with Format 1 but not Format 2. In response, device 500 has switched to playing Dance Song in Format 1 rather than in Format 2 via output device 501a, and is no longer displaying selectable option 616a in user interface 601. In some embodiments, if the currently-active output device of device 500 switches back to an output device that is compatible with Format 2, device 500 would optionally automatically switch to playing Dance Song in Format 2 via that output device, and would optionally re-display selectable option 616a in the selected or activated state in user interface 601.

In some embodiments, if device 500 detects selection of selectable option 616a while it is playing a content item in Format 2, device 500 will switch back to playing the content item in Format 1. For example, in FIG. 6P, device 500 is playing Dance Song in Format 2 via output device 501b, which is compatible with Format 1 and Format 2. Device 500 detects selection of selectable option 616a (e.g., via contact 603p). In response, device 500 switches to playing Dance Song in Format 1, and displays selectable option 616a in the unselected or deactivated state in user interface 601, as shown in FIG. 6Q. As previously described, device 500 optionally continues playback of Dance Song from the playback position at which it was when selection of selectable option 616a in FIG. 6P was detected.

FIG. 6R illustrates an example content browsing user interface 605 (e.g., of a content browsing and playback application of which user interface 601 is a user interface). In some embodiments, device 500 displays user interface 601 in response to selection of a representation of a content item displayed in user interface 605, as will be described below. In FIG. 6R, the content browsing user interface 605 includes a Hot Tracks section 630 that includes representations 631 of various content items (e.g., the five most popular songs available from the content browsing and playback application), and a Top Albums section 632 that includes representations 633 of various collections of content items (e.g., the five most popular albums available from the content browsing and playback application). In some embodiments, selection of a representation 633 (e.g., selection of 633a) corresponding to a collection of content items causes device 500 to display a user interface corresponding to the collection of content items (e.g., a user interface that includes representations of songs included in the album).

Representations 631 of content items optionally include imagery or artwork corresponding to the content items, the name/title of the content items, the name of the artist and/or band that created the content items, download affordances 634 that are selectable to initiate a process to download the content items to device 500, and/or format indications 636 that indicate the format in which the content items are available. For example, if device 500 detects selection of download affordance 634b, device 500 optionally initiates a process to download “Artsy Song” to device 500. Further, because “Rock Tune” is available from the content browsing and playback application in Format 2 (e.g., and Format 1), device 500 displays representation 631a including the Format 2 visual indication 636a. In some embodiments, device 500 does not display a Format 1 visual indication in representations of content items that are available in Format 1, because Format 1 is optionally the default format in which all or almost all content items are available via the content browsing and playback application. As another example, because “Artsy Song” is available from the content browsing and playback application in Format 2 and Format 4, device 500 displays representation 631b including the Format 2 visual indication and the Format 4 visual indication 636b.

In some embodiments, Format 1 and Format 2 described herein correspond to the number and/or type of audio channels in a content item and/or the manner in which audio position information is represented in a content item (e.g., mono, stereo, surround, spatial), and Format 3, Format 4, and Format 5 described herein correspond to the compression, codec, sample rate, and/or bit depth of (e.g., the audio of) a content item (e.g., lossy compression, lossless compression, high-resolution lossless compression). For example, Format 1 is optionally stereo sound, Format 2 is optionally surround and/or spatial sound, Format 3 is optionally sound in a lossy compression format, Format 4 is optionally sound in a lossless compression format, and Format 5 is optionally sound in a high-resolution lossless compression format. In some embodiments, any of Format 1, 2, 3, 4 and 5 described herein, and their corresponding features described herein, apply to any of the number and/or type of audio channels in a content item and/or the manner in which audio position information is represented in a content item and/or the compression, codec, sample rate, and/or bit depth of a content item. Further, as described herein, Formats 3, 4 and 5 are not necessarily different from Formats 1 and 2 (e.g., in some embodiments, Formats 1 and 2 are different formats, and Formats 3, 4, and 5 are different formats, though Format 1 is the same as Format 3, for example), though in some embodiments, Formats 3, 4 and 5 are different from Formats 1 and 2.

As mentioned previously, in some embodiments, content items can be downloaded to device 500. For example, if device 500 detects selection of download affordance 634d in FIG. 6R, device 500 optionally downloads “Upbeat Song” to device 500 (e.g., in Format 1). However, if the content item being downloaded is available in multiple formats, device 500 optionally prompts the user to specify the format in which to download the content item. For example, in FIG. 6S, device 500 detects selection of download affordance 634e (e.g., via contact 603s). In response, because “Hit Song” is available in Format 1 and Format 2, device displays prompt 638 (e.g., overlaid on user interface 605) that asks for confirmation about whether device 500 should download “Hit Song” in Format 1 or in Format 2, as shown in FIG. 6T. In some embodiments, downloading in Format 2 requires more storage space (e.g., on device 500) than does downloading in Format 1. In some embodiments, device 500 only displays prompt 638 if the current download operation is the first (or less than a threshold number, such as 2, 3, 5) input to download a content item to device 500 that is available in Format 2. As shown in FIG. 6T, prompt 638 includes a first selectable option 640a that is selectable to download “Hit Song” to device 500 in Format 1, and a second selectable option 640b that is selectable to download “Hit Song” to device 500 in Format 2.

In some embodiments, device 500 displays different visual indications in content playback user interface 601 depending on whether the currently-playing content item is being played in Format 3, Format 4 or Format 5. For example, in FIG. 6U, Dance Song is currently playing on device 500, is available in Formats 3, 4, and 5, and device 500 is playing Dance Song via output device 501d. Output device 501d, and the output signal path from and including device 500 to and including output device 501d, is capable of reproducing Dance Song in Formats 3, 4 and 5 (e.g., is an output signal path that can carry, transmit and/or reproduce lossy audio, lossless audio and high-resolution lossless audio). Because device 500 is playing Dance Song in Format 3 (e.g., a default format for content available via the content browsing and playback application), device 500 optionally does not display an indication of the currently-playing format of Dance Song in user interface 601, such as shown in FIG. 6U.

In some embodiments, the enabling of a device setting (e.g., a setting of an operating system of device 500) that allows for playback of content items in Format 4 causes device 500 to play content items in Format 4 rather than Format 3 if those content items are available in Format 4. For example, in FIG. 6V, the above-described device setting for allowing playback of content items in Format 4 has been enabled. Therefore, device 500 is playing Dance Song in Format 4 rather than in Format 3, as in FIG. 6U. Further, because device 500 is playing Dance Song in Format 4, device 500 displays a Format 4 indication 650a in user interface 601 in FIG. 6V that indicates that the format of the currently-playing content item is Format 4.

In some embodiments, Format 4 indication 650a is selectable to display information associated with Format 4. For example, in FIG. 6W, device 500 detects selection of Format 4 indication 650a (e.g., via contact 603w). In response, device 500 displays user interface 652 (e.g., overlaid on user interface 601). User interface 652 optionally indicates the format in which Dance Song is being played back, information about the bitrate, bit depth and/or sample rate at which Dance Song is being played back, and/or additional information about Format 4. In some embodiments, if Dance Song is available in a higher-quality format than Format 4, user interface 652 includes information that Dance Song is available in the higher-quality format than Format 4 (e.g., information about the highest quality format in which Dance Song is available). For example, in FIG. 6X, Dance Song is also available in Format 5; therefore, user interface 652 includes an indication that Dance Song is also available in Format 5 (e.g., the highest-quality format in which Dance Song is available). Additionally, user interface 652 optionally includes a selectable option 654 that is selectable to display a settings user interface of device 500 (e.g., a user interface of the operating system of device 500 rather than a user interface of the content browsing and playback application) from which playback of content items in Format 5 can be enabled.

In FIG. 6X, device 500 detects selection of selectable option 654. In response, device 500 displays settings user interface 607, as shown in FIG. 6Y. As previously described, settings user interface 607 is optionally a user interface of the operating system of device 500. User interface 607 optionally includes a control 658 that is selectable to enable/disable playback of content items in Format 5, and a control 660 that is selectable to enable/disable a setting that causes device 500 to play a content item in Format 2 rather than Formats 4 and/or 5 when that content item is available in Formats 2 and 4 and/or 5 (e.g., and optionally Formats 1 and/or 3). In FIG. 6Y, control 658 is disabled, so device 500 does not play content items in Format 5 even if they are available in Format 5. For example, in FIG. 6Y, device 500 is playing Dance Song in Format 4, as described with reference to FIG. 6V. In FIG. 6Y, device 500 detects selection of control 658 (e.g., via contact 603y) for enabling control 658 for playing content items in Format 5, when available. In response, device 500 optionally displays user interface 662 (e.g., overlaid on settings user interface 607), as shown in FIG. 6Z, that indicates that playback of content items in Format 5 requires particular (e.g., external) components with capability for carrying signals for and/or reproducing content in Format 5. For example, in some embodiments, Format 5 is a high-resolution lossless audio format, and full reproduction of audio in that format requires particular digital-to-analog converter(s) (DAC(s)) connected to device 500 that are capable of reproducing audio playback in Format 5. In some embodiments, device 500 does not include such components itself.

User interface 662 optionally includes selectable option 664a that is selectable to confirm the enabling of control 658, selectable option 664b that is selectable to cancel the enabling of control 658, and selectable option 664c that is selectable to display a user interface with more information about Format 5 and/or its requirements.

In FIG. 6Z, device 500 detects selection of selectable option 664a, which enables playback of content items in Format 5 via device 500. For example, in FIG. 6AA, device 500 has now switched to playing Dance Song in Format 5, because control 658 was enabled in response to the input detected in FIG. 6Z. Because Dance Song is available in Format 5, and control 658 is enabled, device 500 is playing Dance Song in Format 5, and displays indication 650b in user interface 601 that indicates that Dance Song is being played in Format 5, as shown in FIG. 6AA. Further, because the currently-active output device 501d and/or the currently-active output signal path from and including device 500 to and including output device 501d is capable of reproducing Dance Song in Format 5, device 500 displays indication 650b without displaying an indication that the currently-active output signal path is not able to reproduce Dance Song in Format 5.

However, in FIG. 6BB, the currently-active output device has switched to output device 501e, which optionally does not have the capability to reproduce Dance Song in Format 5, and/or the currently-active output signal path is not otherwise able to reproduce Dance Song in Format 5. Device 500 optionally detects this issue with the currently-active output signal path, and modifies display of indication 650b to include indication 660 (e.g., a yellow dot) that indicates that the currently-active output signal path cannot reproduce Dance Song in Format 5. Device 500 optionally displays a different indication and/or modifies display of indication 650b in a different manner (e.g., highlights indication 650b, changes the color of indication 650b, etc.) to convey the same information. Indication 660 can, therefore, provide an indication to a user that resources (e.g., memory, internet bandwidth, etc.) that are being consumed to playback Dance Song in Format 5 are optionally being consumed for no reason, as Dance Song is not capable of being reproduced in Format 5 with the currently-active output signal path.

In some embodiments, indication 650b and/or 660 is selectable to display information associated with the playback of Dance Song in Format 5 and/or provide for a mechanism to change settings of device 500 to adjust the playback format of Dance Song. For example, in FIG. 6CC, device 500 detects selection of indication 650b (e.g., via contact 603cc). In response, device 500 displays user interface 670 (e.g., overlaid on user interface 601), as shown in FIG. 6DD. User interface 670 optionally includes one or more of information indicating that Dance Song is being played back in Format 5, information about the bitrate, bit depth, and/or sample rate at which Dance Song is being played back, information about Format 5, and an indication that Format 5 is the highest quality format in which Dance Song is available. User interface 670 optionally includes selectable option 674 that is selectable to cease display of user interface 670 (e.g., and unobscure the display of user interface 601) without changing device settings associated with Format 5.

In some embodiments, if the currently-active output signal path of device 500 is not able to reproduce Dance Song in Format 5, user interface 670 includes an indication that the currently-active output signal path of device 500 is not able to reproduce Dance Song in Format 5 and/or information about why the currently-active output signal path of device 500 is not able to reproduce Dance Song in Format 5 (e.g., because the currently-active output device is not capable of the reproduction, because the communication pathway (e.g., Bluetooth) between device 500 and the currently-active output device is not capable of carrying signals for the reproduction, etc.). User interface 670 optionally also includes selectable option 672 that is selectable to display a settings user interface of device 500 (e.g., user interface 607 shown and described with reference to FIG. 6Y) from which settings for controlling whether device 500 will play Dance Song in Format 5 (or in Format 3 or 4) can be controlled. For example, from settings user interface 607, a user is optionally able to disable playback of content items (e.g., including Dance Song) in Format 5, in which case device 500 would optionally playback Dance Song in Format 4 (e.g., such as shown and described with reference to FIG. 6V).

FIG. 7 is a flow diagram illustrating a method 700 for facilitating selection of a format for the playback of content. The method 700 is optionally performed at an electronic device such as device 100, device 300, and device 500 as described above with reference to FIGS. 1A-1B, 2-3, 4A-4B and 5A-5H. Some operations in method 700 are, optionally combined and/or the order of some operations is, optionally, changed.

As described below, the method 700 provides ways in which an electronic device facilitates selection of a format for the playback of content. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed at an electronic device (e.g., device 500) in communication with a display generation component (e.g., 504) and one or more input devices, such as described with reference to FIG. 6A. For example, a mobile device (e.g., a tablet, a smartphone, a media player, or a wearable device), a set-top box or a computer, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc. In some embodiments, the display generation component is a display integrated with the electronic device (optionally a touch screen display in which the display generation component includes an input device), external display such as a monitor, projector, television, or a hardware component (optionally integrated or external) for projecting a user interface or causing a user interface to be visible to one or more users, etc.

In some embodiments, while displaying, via the display generation component, a content playback user interface for a first content item (e.g., a song, music, a video, etc.) that is playing at the electronic device, such as user interface 601 in FIG. 6C (e.g., a user interface that includes one or more of an image corresponding to the first content item (e.g., album art for the content item), a scrubber bar for controlling the current playback position within the first content item, one or more playback controls (e.g., backward skip, forward skip, play/pause) for controlling playback of the first content item, a volume control for controlling the volume of the playback of the first content item, or a selectable option that is selectable to initiate a process to select the output device via which the electronic device should playback the first content item (e.g., selection of the selectable option causes display of a menu of available output devices from which the audio and/or video from the first content item is to be played, including the (e.g., speakers included in the) electronic device, an external television, an external speaker(s), external headphones, etc., and selection of an option in the menu causes the electronic device to playback the first content item from the selected output device.). In some embodiments, the content playback user interface is a user interface of a music application on the electronic device via which a plurality of content items are browsable and playable. In some embodiments, the content playback user interface is displayed by the electronic device in response to detecting selection of a representation of the first content item from a content browsing user interface of the music application), wherein the electronic device is playing the first content item in a first format (702), such as playing Chill Song in Format 1 in FIG. 6C (e.g., playing the first content item in stereo sound, in mono sound. In some embodiments, potential formats for a content item include stereo sound, mono sound, surround sound, spatial (e.g., 3D) sound, lossy (e.g., compressed) format, lossless (e.g., uncompressed) format, high resolution uncompressed format, etc.), in accordance with a determination that the first content item is available in a second format, different from the first format, such as Chill Song being available in Format 2 in FIG. 6C (e.g., the first content item is available for playback via the music application in a plurality of formats, including the first format and the second format. For example, the first format is optionally a stereo or mono sound format, and the second format is optionally a surround sound format, or a spatial (e.g., 3D) sound format in which headphones connected to the device, for example, generate the audio of the first content item such that the source of the audio appears to be anchored to the position of the electronic device, even if the orientation and/or position of the headphones changes relative to the electronic device (e.g., due to the user turning their head and/or due to movement of the electronic device)), and that a currently-active output device for playing the first content item (e.g., the output device via which the electronic device is currently playing back the first content item) is compatible with the second format, such as output device 501b being compatible with Format 2 in FIG. 6C (e.g., in some embodiments, not every output device is able to playback the first content item in the second format (e.g., surround sound format or spatial audio format). In some embodiments, headphones (or other output devices) that include one or more inertial measurement units (IMUs) circuitry and/or otherwise include circuitry for detecting (e.g., changes in) the orientation and/or position of the headphones (e.g., relative to the electronic device) and/or circuitry for communicating such information to the electronic device are compatible with the second format. In some embodiments, output devices (e.g., headphones or other output devices) that do not include such circuitry are optionally not compatible with the second format. In some embodiments, output devices that include circuitry and/or speakers that are able to reproduce surround sound are compatible with the second format, and output devices that do not include circuitry and/or speakers that are able to reproduce surround sound are not compatible with the second format.), the electronic device displays (704), in the content playback user interface, a selectable option that is selectable to initiate a process to switch from playing the first content item in the first format to playing the first content item in the second format, such as selectable option 616a in FIG. 6C. For example, if the first content item is available for playback from the music application in the second format, and if the currently active output device supports and/or is compatible with the second format, the electronic device displays a selectable option in the content playback user interface for switching playback of the first content item to the second format. In some embodiments, in response to detecting the selection of the selectable option, the electronic device transitions to playing the first content item in the second format rather than the first format. In some embodiments, the electronic device continues playback of the first content item in the second format from the same content playback location at which the first content item was being played when the electronic device detected the selection of the selectable option. In some embodiments, the selectable option is displayed concurrently with the other elements of the content playback user interface described previously (e.g., scrubber bar, playback controls, etc.). The above-described manner of displaying the selectable option for switching formats for the playback of the content item provides for a quick and efficient method of allowing for the switching of content playback formats during playback of the content, but only when the switched-to format is compatible with the output device that will be playing the content item, which simplifies the interaction between the user and the electronic device and enhances the operability of the electronic device and makes the user-device interface more efficient (e.g., by avoiding erroneous switching of formats when the format is not compatible with the currently active output device), which additionally reduces power usage and improves battery life of the electronic device by enabling the user to use the electronic device more quickly and efficiency, while reducing errors in usage.

In some embodiments, in accordance with a determination that the playing of the first content item is a first playback of a content item that is available in the second format (e.g., this is the first time (or fewer than a threshold number of times) the electronic device is playing back a content item that is available in the second format), the selectable option is displayed in a first manner, such as selectable option 616a being displayed with indication 622 in FIG. 6C (e.g., the electronic device highlights, glows, or otherwise modifies the display characteristics of the selectable option, such as changing its color, displaying it bolded, etc.), and in accordance with a determination that the playing of the first content item is not a first playback of a content item that is available in the second format (e.g., the electronic device has previously played a content item that is available in the second format, or the electronic device has played a content item that is available in the second format more than the threshold number of times), the selectable option is displayed in a second manner, different from the first manner, such as selectable option 616a being displaying without indication 622 in FIG. 6C (e.g., the electronic device does not highlight, does not glow, or otherwise does not modify the display characteristics of the selectable option, such as displaying the selectable option at its original color, displaying the selectable option not bolded, etc.). In some embodiments, in response to receiving an input to play the first content item, and in accordance with the determination that the playing of the first content item is the first time (or fewer than the threshold number of times) the electronic device has played a content item that is available in the second format, the electronic device displays (e.g., overlaid on the content playback user interface) a user interface that includes information about the second format. The above-described manner of highlighting the selectable option for switching formats for the playback of the content item provides for a quick and efficient method of indicating the existence of the selectable option, which simplifies the interaction between the user and the electronic device and enhances the operability of the electronic device and makes the user-device interface more efficient (e.g., by avoiding unnecessary inputs for switching of formats when formats can instead be switched efficiently via the selectable option), which additionally reduces power usage and improves battery life of the electronic device by enabling the user to use the electronic device more quickly and efficiency, while reducing errors in usage.

In some embodiments, while displaying, via the display generation component, the content playback user interface for the first content item that is playing at the electronic device, in accordance with a determination that the currently-active output device for playing the first content item is not compatible with the second format, the electronic device forgoes displaying the selectable option in the content playback user interface, such as shown in FIG. 6B. Therefore, in some embodiments, if the currently-active output device is not compatible with the second format, the electronic device does not display the selectable option at all in the content playback user interface. In some embodiments, if the currently-active output device is not compatible with the second format, the electronic device does display the selectable option in the content playback user interface, but selection of the selectable option causes the electronic device to display a warning message that indicates that the currently-active output device is not compatible with the second format. In some embodiments, the warning message includes a selectable option to cancel the transition to playing the first content item in the second format, and a selectable option to continue with the transition to playing the first content item in the second format. The above-described manner of not displaying the selectable option for switching formats for the playback of the content item ensures the format of the content item is not switched to one with which the currently-active output device is not compatible, which simplifies the interaction between the user and the electronic device and enhances the operability of the electronic device and makes the user-device interface more efficient (e.g., by avoiding erroneous inputs for switching formats of the content item), which additionally reduces power usage and improves battery life of the electronic device by enabling the user to use the electronic device more quickly and efficiency, while reducing errors in usage.

In some embodiments, while displaying, via the display generation component, the content playback user interface for the first content item that is playing at the electronic device, in accordance with a determination that compatibility of the currently-active output device for playing the first content item with the second format is unknown (e.g., the electronic device is not able to determine whether the currently-active output device is compatible with the second format, because, for example, the currently-active output device does not transmit information about its capabilities and/or compatibilities to the electronic device), the electronic device displays, in the content playback user interface, a selectable option that is selectable to display a visual indication that the currently-active output device may not be compatible with the second format, such as shown in FIGS. 6F-6H (e.g., a warning message that indicates that the currently-active output device may not be compatible with the second format). In some embodiments, the warning message includes a selectable option to cancel the transition to playing the first content item in the second format, and a selectable option to continue with the transition to playing the first content item in the second format. The above-described manner of displaying the visual indication provides a quick and efficient manner of indicating that the currently-active output device may not be compatible with the second format, while still allowing for switching if the currently-active output device actually is compatible with the second format, which simplifies the interaction between the user and the electronic device and enhances the operability of the electronic device and makes the user-device interface more efficient (e.g., by avoiding erroneous inputs for switching formats of the content item if the currently-active output device may not be compatible with the format being switched-to), which additionally reduces power usage and improves battery life of the electronic device by enabling the user to use the electronic device more quickly and efficiency, while reducing errors in usage.

In some embodiments, the electronic device detects, via the one or more input devices, selection of the selectable option, such as shown in FIG. 6D (e.g., a touch input, such as a tap of a contact, detected on the selectable option, which is displayed on a touch screen). In some embodiments, in response to detecting the selection of the selectable option, the electronic device continues playback of the first content item in the second format from a playback position at which the first content item was playing when the selection of the selectable option was detected, such as shown in FIG. 6E. In some embodiments, the electronic device transitions to playing the first content item in the second format, and continues playback of the first content item from its current playback position (e.g., without restarting playback of the first content item). The above-described manner of continuing playback of the content item from its current playback position avoids the need for subsequent input to change the current playback position to the desired playback position after switching to the second format, which simplifies the interaction between the user and the electronic device and enhances the operability of the electronic device and makes the user-device interface more efficient, which additionally reduces power usage and improves battery life of the electronic device by enabling the user to use the electronic device more quickly and efficiency, while reducing errors in usage.

In some embodiments, the currently-active output device is an external device with which the electronic device is in communication, such as described with reference to output devices 501a, 501b, 501c, 501d and/or 501e. For example, the currently-active output device is external headphones/earbuds/speakers/television/set-top box that are connected to and/or in communication with the electronic device via wired or wireless communication (e.g., Bluetooth, Wi-Fi, etc.). In some embodiments, the electronic device includes integrated speakers that are able to play content at the electronic device, and can be designated as the currently-active output device (e.g., instead of the external device).

In some embodiments, the electronic device detects, via the one or more input devices, selection of the selectable option, such as shown in FIG. 6D (e.g., a touch input, such as a tap of a contact, detected on the selectable option, which is displayed on a touch screen). In some embodiments, in response to detecting the selection of the selectable option, the electronic device enables a setting of an operating system of the electronic device that enables playback of content in the second format by the currently-active output device. For example, in some embodiments, the operating system of the electronic device includes a setting associated with the currently-active output device that enables or disables playback of audio in the second format via the currently-active output device. In some embodiments, the value of the setting is specific to a given output device such that if the currently-active output device were to change, the value of the setting would be the value of the setting for the changed output device, and not the prior output device. In some embodiments, the setting can be enabled/disabled in a settings user interface of the operating system of the electronic device (e.g., not a user interface of the content playback application of which the content playback user interface is a user interface). In some embodiments, when the setting is enabled, the currently-active output device is able to play content in the second format via a plurality of different applications installed on the device (e.g., including the application of which the content playback user interface is a user interface). In some embodiments, when the setting is disabled, the currently-active output device is not able to play content in the second format in any of the plurality of different applications installed on the device—instead, the electronic device optionally plays content in the first format in the plurality of different applications installed on the device. The above-described manner of enabling the operating system setting in conjunction with selection of the selectable option provides a quick and efficient manner of configuring the electronic device in a way that allows for playback of content in the second format, which simplifies the interaction between the user and the electronic device and enhances the operability of the electronic device and makes the user-device interface more efficient (e.g., by not requiring additional input from the user to correctly configure the electronic device), which additionally reduces power usage and improves battery life of the electronic device by enabling the user to use the electronic device more quickly and efficiency, while reducing errors in usage.

In some embodiments, the electronic device detects, via the one or more input devices, selection of the selectable option, such as shown in FIG. 6D (e.g., a touch input, such as a tap of a contact, detected on the selectable option, which is displayed on a touch screen). In some embodiments, without detecting further input directed to the selectable option (e.g., without detecting any further selection of the selectable option while playing the first content item or the second content item or the third content item described below), in response to detecting the selection of the selectable option, the electronic device continues playback of the first content item in the second format, such as shown in FIG. 6E (e.g., transition to playing the first content item in the second format. In some embodiments, in response to detecting the selection of the selectable option, the electronic device continues to display the selectable option in the content playback user interface (e.g., optionally, with a different color, shading, brightness, etc.), and selection of the selectable option would cause the electronic device to transition back to playing the first content item in the first format (e.g., continue playback of the first content item in the first format)). In some embodiments, after playing the first content item, the electronic device plays a second content item that is available in the first format and not available in the second format (e.g., the second content item is the next content item after the first content item in a playlist or other sequence of content items that is currently being played. In some embodiments, the electronic device transitions from playing the first content item to playing the second content item automatically (e.g., without user input) when the current playback position reaches the end of the first content item), wherein the electronic device is playing the second content item in the first format, such as Fast Song in FIG. 6L (e.g., because the second content item is not available in the second format, the electronic device plays the second content item in the first format. In some embodiments, because the second content item is not available in the second format, the electronic device does not display the selectable option in the content playback user interface while playing the second content item). In some embodiments, after playing the second content item, the electronic device plays a third content item that is available in the first format and the second format (e.g., the third content item is the next content item after the second content item in a playlist or other sequence of content items that is currently being played. In some embodiments, the electronic device transitions from playing the second content item to playing the third content item automatically (e.g., without user input) when the current playback position reaches the end of the second content item), wherein the electronic device is playing the third content item in the second format, such as Dance Song in FIG. 6N (e.g., because the third content item is available in the second format, the electronic device plays the third content item in the second format without requiring additional user input (e.g., after the selection of the selectable option while the electronic device was playing the first content item)). In some embodiments, while playing the third content item in the second format, the electronic device redisplays the selectable option in the content playback user interface, and the selectable option is selectable to cause the electronic device to transition to playing the third content item in the first format (e.g., continue playback of the third content item in the first format)). Therefore, in some embodiments, the electronic device plays a future content item that is available in the second format in the second format, even when there is an intervening content item that is not available in the second format, without requiring the user to provide additional input selecting the second format for playback. The above-described manner of maintaining the last-provided setting for playback of content in the second format provides a quick and efficient manner of continuing playback of content items in the second format, when available, which simplifies the interaction between the user and the electronic device and enhances the operability of the electronic device and makes the user-device interface more efficient (e.g., by avoiding the need for additional input for enabling the second format each time the electronic device plays a content item that is not available in the second format), which additionally reduces power usage and improves battery life of the electronic device by enabling the user to use the electronic device more quickly and efficiency, while reducing errors in usage.

In some embodiments, while playing the first content item in the second format via a first output device, the electronic device detects that the currently active output device has changed from the first output device to a second output device (e.g., the electronic device has detected user input to change the currently-active output device from a first set of headphones to a second set of headphones while playing the first content item, or from the first set of headphones to the internal speakers of the electronic device while playing the first content item), wherein the second output device is not compatible with the second format, such as output device 501a in FIG. 6O (e.g., the first set of headphones is compatible with the second format, but the second set of headphones or the internal speakers of the electronic device are not compatible with the second format. In some embodiments, the currently-active output device provides the electronic device with information about the compatibility of the currently-active output device with one or more formats, including one or more of the first and second formats.). In some embodiments, in response to detecting that the second output device is the currently-active output device, the electronic device continues playback of the first content item in the first format, such as shown in FIG. 6O. For example, the electronic device transitions back to playing the first content item in the first format, and continues playback of the first content item from its current playback position (e.g., without restarting playback of the first content item). In some embodiments, the electronic device does not require user input to transition to playing the first content item in the first format (e.g., other than the input for changing the currently-active output device). In some embodiments, the electronic device ceases to display the selectable option in the content playback user interface while the currently-active output device does not support the second format. The above-described manner of automatically switching playback formats based on the currently-active output device provides a quick and efficient manner of ensuring the current playback format is compatible with the currently-active output device, which simplifies the interaction between the user and the electronic device and enhances the operability of the electronic device and makes the user-device interface more efficient (e.g., by avoiding erroneous pairing of playback formats with currently-active output devices and additional user inputs for switching output formats), which additionally reduces power usage and improves battery life of the electronic device by enabling the user to use the electronic device more quickly and efficiency, while reducing errors in usage.

In some embodiments, while playing the first content item in the first format via the second output device, the electronic device detects that the currently active output device has changed from the second output device to a third output device (e.g., the first output device or another output device), wherein the third output device is compatible with the second format, such as output device 501b in FIG. 6P (e.g., the electronic device has detected user input to change the currently-active output device from the second set of headphones to a third set of headphones while playing the first content item, or from the internal speakers of the electronic device to the third set of headphones while playing the first content item. In some embodiments, the second set of headphones or the internal speakers of the electronic device are not compatible with the second format, but the third set of headphones is compatible with the second format. In some embodiments, the currently-active output device provides the electronic device with information about the compatibility of the currently-active output device with one or more formats, including one or more of the first and second formats.). In some embodiments, in response to detecting that the third output device is the currently-active output device, the electronic device continues playback of the first content item in the second format, such as shown in FIG. 6P. For example, the electronic device transitions back to playing the first content item in the second format, and continues playback of the first content item from its current playback position (e.g., without restarting playback of the first content item). In some embodiments, the electronic device does not require user input to transition to playing the first content item in the second format (e.g., other than the input for changing the currently-active output device). In some embodiments, the electronic device redisplays the selectable option in the content playback user interface while the currently-active output device does support the second format. The above-described manner of automatically switching playback formats back based on the currently-active output device provides a quick and efficient manner of returning to the previously-designated output format for a given output device, which simplifies the interaction between the user and the electronic device and enhances the operability of the electronic device and makes the user-device interface more efficient (e.g., by avoiding erroneous pairing of playback formats with currently-active output devices and additional user inputs for switching output formats), which additionally reduces power usage and improves battery life of the electronic device by enabling the user to use the electronic device more quickly and efficiency, while reducing errors in usage.

In some embodiments, the electronic device displays, via the display generation component, a content browsing user interface including a plurality of representations of content items available for playback at the electronic device, such as user interface 605 in FIG. 6R (e.g., a user interface that includes representations of songs, albums, and/or playlists that are available for playback. The representations are optionally selectable to initiate processes to play content corresponding to the selected representation), wherein in accordance with a determination that a respective content item is available in the second format, a respective representation of the respective content item in the content browsing user interface includes a visual indication that indicates the respective content item is available in the second format, such as the Format 2 and/or Format 4 indications in FIG. 6R (e.g., if a song is available in the second format, the representation of the song is optionally displayed with (e.g., next to or including) a badge or other visual indication (e.g., “Format 2”) that indicates the song is available in the second format. In some embodiments, the representation of a collection of songs (e.g., a representation of an album or a representation of a playlist) is optionally displayed with (e.g., next to or including) a badge or other visual indication (e.g., “Format 2”) that indicates the collection of songs is available in the second format if every song included in the collection of songs is available in the second format. In some embodiments, in response to detecting selection of the badge or visual indication, the electronic device displays a user interface that includes information about the second format). In some embodiments, in accordance with a determination that the respective content item is not available in the second format, the respective representation of the respective content item in the content browsing user interface does not include the visual indication. For example, if a song is not available in the second format, the representation of the song is optionally not displayed with a badge or other visual indication (e.g., “Format 2”) that indicates the song is available in the second format. In some embodiments, the representation of a collection of songs (e.g., a representation of an album or a representation of a playlist) is optionally not displayed with a badge or other visual indication (e.g., “Format 2”) that indicates the collection of songs is available in the second format if not every song included in the collection of songs is available in the second format (e.g., if at least one song in the collection of songs is not available in the second format). The above-described manner of indicating the playback formats in which content is available provides a quick and efficient manner of indicating the available playback formats, which simplifies the interaction between the user and the electronic device and enhances the operability of the electronic device and makes the user-device interface more efficient (e.g., by avoiding erroneous inputs for accessing content items that are not available in the playback format desired), which additionally reduces power usage and improves battery life of the electronic device by enabling the user to use the electronic device more quickly and efficiency, while reducing errors in usage.

In some embodiments, the electronic device detects, via the one or more input devices, an input corresponding to a request to download, to the electronic device, a respective content item, such as shown in FIG. 6S (e.g., a selection of a “download” button displayed with a representation of the respective content item in a content browsing user interface). In some embodiments, in response to detecting the input, in accordance with a determination that the respective content item is available in the second format and that the request to download the respective content item is a first request to download a content item available in the second format to the electronic device (e.g., if this input is the first input (or less than a threshold number of inputs, such as 2, 3, 5) detected at the electronic device for downloading a content item that is available in the second format), the electronic device displays, via the display generation component, a confirmation user interface for confirming whether to download the respective content item in the first format or the second format, such as shown in FIG. 6T. For example, the electronic device displays a user interface that indicates that downloading the respective content item in the second format may (e.g., will) require more storage space on the electronic device than downloading the respective content item in the first format. The user interface that is displayed optionally includes a first selectable option that is selectable to download the respective content item to the electronic device in the first format, and a second selectable option that is selectable to download the respective content item to the electronic device in the second format. The above-described manner of displaying the confirmation user interface provides a quick and efficient manner of ensuring the format and/or storage requirements of the download, which simplifies the interaction between the user and the electronic device and enhances the operability of the electronic device and makes the user-device interface more efficient (e.g., by avoiding erroneous downloading of the wrong format and/or erroneous utilization of storage), which additionally reduces power usage and improves battery life of the electronic device by enabling the user to use the electronic device more quickly and efficiency, while reducing errors in usage.

In some embodiments, while displaying, via the display generation component, a content playback user interface for a second content item (e.g., a song, music, a video, etc.) that is playing at the electronic device, such as user interface 601 in FIG. 6AA (e.g., a user interface that includes one or more of an image corresponding to the second content item (e.g., album art for the content item), a scrubber bar for controlling the current playback position within the second content item, one or more playback controls (e.g., backward skip, forward skip, play/pause) for controlling playback of the second content item, a volume control for controlling the volume of the playback of the second content item, or a selectable option that is selectable to initiate a process to select the output device via which the electronic device should playback the second content item (e.g., selection of the selectable option causes display of a menu of available output devices from which the audio and/or video from the second content item is to be played, including the (e.g., speakers included in the) electronic device, an external television, an external speaker(s), external headphones, etc., and selection of an option in the menu causes the electronic device to playback the second content item from the selected output device.). In some embodiments, the content playback user interface is a user interface of a music application on the electronic device via which a plurality of content items are browsable and playable. In some embodiments, the content playback user interface is displayed by the electronic device in response to detecting selection of a representation of the second content item from a content browsing user interface of the music application), the electronic device displays, in the content playback user interface, a visual indication of a currently-playing format of the second content item, such as indication 650b in FIG. 6AA (e.g., if the electronic device is playing the second content item in surround sound, the content playback user interface includes a visual indication that the electronic device is playing the second content item in surround sound (e.g., “Surround”)). In some embodiments, if the electronic device is playing the second content item in a lossless audio format, the content playback user interface includes a visual indication that the electronic device is playing the second content item in the lossless audio format (e.g., “Lossless”). In some embodiments, if the electronic device is playing the second content item in a high-resolution lossless audio format, the content playback user interface includes a visual indication that the electronic device is playing the second content item in the high-resolution lossless audio format (e.g., “Hi-Res Lossless”). In some embodiments, if the electronic device is playing the second content item in a lossy audio format, the content playback user interface includes a visual indication that the electronic device is playing the second content item in the lossy audio format (e.g., “Lossy”) or does not include such a visual indication in the content playback user interface.

In some embodiments, in accordance with a determination that an output signal path including the currently-active output device is not capable of playing the second content item in the currently-playing format, the visual indication is displayed in a first manner, such as indication 650b displayed with indication 660 in FIG. 6BB (e.g., if the current output signal path from the circuitry in the electronic device that generates the output (e.g., audio, video) of the content to the currently-active output device, including the currently-active output device, is not capable of transmitting, carrying, and/or otherwise reproducing the second content item in the currently-playing format, the visual indication is optionally displayed with a modified appearance (e.g., with a yellow dot, with a greyed out appearance, in greyscale)). For example, if the electronic device is playing the second content item in a high-resolution lossless format, but the currently-active output device is connected to the electronic device via Bluetooth (e.g., which optionally cannot carry the necessary data for high-resolution lossless audio), the electronic device optionally displays the “Hi-Res Lossless” visual indication with a yellow dot above it. In some embodiments, in accordance with a determination that the output signal path including the currently-active output device is capable of playing the second content item in the currently-playing format, the visual indication is displayed in a second manner, different from the first manner, such as indication 650b displayed without indication 660 in FIG. 6AA. For example, if the current output signal path from the circuitry in the electronic device that generates the output (e.g., audio, video) of the content to the currently-active output device, including the currently-active output device, is capable of transmitting, carrying, and/or otherwise reproducing the second content item in the currently-playing format, the visual indication is optionally displayed without the modified appearance (e.g., without a yellow dot, with a full color appearance, in color). For example, if the electronic device is playing the second content item in a high-resolution lossless format, and the currently-active output device is connected to the electronic device via a high-bitrate communication link (e.g., which optionally can carry the necessary data for high-resolution lossless audio), the electronic device optionally displays the “Hi-Res Lossless” visual indication without the yellow dot above it. The above-described manner of displaying a status of the output signal path provides a quick and efficient manner of indicating when the reproduction of the content item may not correspond with the playback format that is currently selected, which simplifies the interaction between the user and the electronic device and enhances the operability of the electronic device and makes the user-device interface more efficient (e.g., by avoiding unnecessary playback of the content in a playback format that is not being reproduced correctly in the output signal path), which additionally reduces power usage and improves battery life of the electronic device by enabling the user to use the electronic device more quickly and efficiency, while reducing errors in usage.

In some embodiments, the electronic device detects, via the one or more input devise, selection of the visual indication, such as shown in FIG. 6CC (e.g., a touch input, such as a tap of a contact, detected on the visual indication, which is displayed on a touch screen). In some embodiments, in response to detecting the selection of the visual indication, the electronic device displays, via the display generation component, a respective user interface associated with the currently-playing format of the second content item (e.g., overlaid on the content playback user interface), wherein the respective user interface includes in accordance with a determination that the second content item is available in a respective format that is higher quality than the currently-playing format, information that indicates the second content item is available in the respective format (e.g., if the electronic device is playing the second content item in a lossless audio format, and the second content item is also available in a high-resolution lossless audio format, the respective user interface includes information that indicates the second content item is available in the high-resolution lossless audio format. In some embodiments, the respective user interface element includes information that indicates the highest quality format in which the second content item is available for playback by the electronic device. In some embodiments, if the electronic device is playing the second content item in the highest-quality format in which the second content item is available, the respective user interface does not include the information that indicates the second content item is available in the respective format), and a selectable option that is selectable to display a user interface from which access to the second content item in the respective format can be enabled, such as shown in FIG. 6DD. For example, if a setting of the operating system for enabling playback of content in the respective format is disabled, the respective user interface includes a selectable option that is selectable to display a settings user interface of the operating system of the electronic device (e.g., not a user interface of the content playback application in which the second content item is being played) that includes a selectable option to enable/disable the setting. In some embodiments, the respective user interface includes the selectable option that is selectable to display the settings user interface even if the setting of the operating system for enabling playback of content in the respective format is not disabled. In some embodiments, if the electronic device detects input for enabling the setting in the settings user interface, the electronic device transitions to playing the second content item in the respective format. In some embodiments, in response to the electronic device detecting input for enabling the setting in the settings user interface for allowing playback of content in the respective format, the electronic device displays a confirmation user interface that indicates that playback of content in the respective format requires particular hardware (e.g., external to the electronic device) that can reproduce content in the respective format (e.g., a particular digital-to-analog converter (DAC)), because, for example, the electronic device is not able to reproduce content in the respective format itself or without the additional particular hardware. In some embodiments, the respective format is the highest-quality format (independent of whether the content is available in mono, stereo, surround, or spatial audio) in which content is available on the electronic device. In some embodiments, the confirmation user interface includes a first selectable option that is selectable to continue with enabling the setting, and a second selectable option that is selectable to cancel enabling the setting (e.g., maintaining the setting as disabled). In some embodiments, the respective user interface additionally or alternatively includes information about the currently-playing format (e.g., a bit depth, bit rate, sample frequency, etc.). In some embodiments, the respective user interface additionally or alternatively includes information about why the output signal path is not capable of reproducing the second content item in the currently-playing format (if this is the case). The above-described manner of displaying the respective user interface provides a quick and efficient manner of accessing the relevant format-related settings of the operating system of the electronic device, which simplifies the interaction between the user and the electronic device and enhances the operability of the electronic device and makes the user-device interface more efficient (e.g., by avoiding erroneous inputs for accessing the settings user interface, or erroneous inputs for enabling the respective format when the content item at issue is not available in the respective format), which additionally reduces power usage and improves battery life of the electronic device by enabling the user to use the electronic device more quickly and efficiency, while reducing errors in usage.

In some embodiments, the electronic device detects, via the one or more input devise, selection of the visual indication, such as shown in FIG. 6CC (e.g., a touch input, such as a tap of a contact, detected on the visual indication, which is displayed on a touch screen). In some embodiments, in response to detecting the selection of the visual indication, the electronic device displays, via the display generation component, a respective user interface associated with the currently-playing format of the second content item (e.g., overlaid on the content playback user interface), wherein the respective user interface includes in accordance with the determination that the output signal path including the currently-active output device is not capable of playing the second content item in the currently-playing format, information that indicates that the output signal path including the currently-active output device is not capable of playing the second content item in the currently-playing format (e.g., if the output signal path includes a Bluetooth connection, and the currently-playing format is a high-resolution lossless format that cannot be transmitted over a Bluetooth connection, the respective user interface includes information that indicates that the second content item may not be fully reproduced in the currently-playing format, and/or information that identifies the issue(s) in the output signal path that prevent reproduction of the second content item in the currently-playing format (e.g., an indication that the Bluetooth connection prevents reproduction of the second content item in the currently-playing format)), and a selectable option that is selectable to display a user interface from which access to the second content item in the currently-playing format can be disabled, such as shown in FIG. 6DD. For example, the respective user interface includes a selectable option that is selectable to display a settings user interface of the operating system of the electronic device (e.g., not a user interface of the content playback application in which the second content item is being played) that includes a selectable option to enable/disable a setting that allows playback of content in the currently-playing format. In some embodiments, if the electronic device detects input for disabling the setting in the settings user interface, the electronic device transitions to playing the second content item in a format other than the currently-playing format (e.g., transitions from playing the second content item in a high-resolution lossless format to playing the second content item in a lossless format). In some embodiments, the respective user interface additionally or alternatively includes information about the currently-playing format (e.g., a bit depth, bit rate, sample frequency, etc.). The above-described manner of displaying the respective user interface provides a quick and efficient manner of accessing the relevant format-related settings of the operating system of the electronic device, which simplifies the interaction between the user and the electronic device and enhances the operability of the electronic device and makes the user-device interface more efficient (e.g., by avoiding erroneous inputs for accessing the settings user interface, or erroneously maintaining enablement of the currently-playing format when the output signal path does not fully reproduce the currently-playing format), which additionally reduces power usage and improves battery life of the electronic device by enabling the user to use the electronic device more quickly and efficiency, while reducing errors in usage.

In some embodiments, content is available at the electronic device in the second format and a third format, and content cannot be played by the electronic device in the second format and the third format concurrently (e.g., the electronic device has access to content in a surround sound or spatial audio format and in a high-resolution lossless format. In some embodiments, the content can be played back in the surround sound or spatial audio format (e.g., with lossy or lossless audio) or in the high-resolution lossless format (e.g., in stereo), but not in both the surround sound or spatial audio format and the high-resolution lossless format). In some embodiments, while playing a respective content item that is available in the second format and the third format, in accordance with a determination that a setting for prioritizing the second format over the third format is enabled, the electronic device plays the respective content item in the second format, such as described with reference to control 660 in FIG. 6Y (e.g., if a setting in a settings user interface of an operating system of the electronic device is enabled that prefers content playback in the surround sound or spatial format over the high-resolution format, the electronic device plays the respective content in the surround sound or spatial format (e.g., using lossy or lossless audio)). In some embodiments, in accordance with a determination that the setting for prioritizing the second format over the third format is not enabled, the electronic device plays the respective content item in the third format, such as described with reference to control 660 in FIG. 6Y (e.g., if a setting in a settings user interface of an operating system of the electronic device is disabled that prefers content playback in the surround sound or spatial format over the high-resolution format, the electronic device plays the respective content in the high-resolution lossless format (e.g. in stereo). Thus, in some embodiments, the second and third formats are not combinable and/or compatible with one another on the electronic device. The above-described manner of providing a setting for setting a preference between two formats that are not combinable on the electronic device provides a quick and efficient manner of the electronic device selecting the correct format when appropriate, which simplifies the interaction between the user and the electronic device and enhances the operability of the electronic device and makes the user-device interface more efficient (e.g., by avoiding additional user inputs for switching formats as the electronic device plays additional content items), which additionally reduces power usage and improves battery life of the electronic device by enabling the user to use the electronic device more quickly and efficiency, while reducing errors in usage.

It should be understood that the particular order in which the operations in method 700 and/or FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 7 are, optionally, implemented by components depicted in FIGS. 1A-1B. For example, displaying operation 704 is optionally implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology potentially involves the gathering and use of data available from specific and legitimate sources to facilitate the display of some information (e.g., the format of currently-playing content or the availability to play content in a different format based on output device compatibility). The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, handwriting styles, etc.

The present disclosure recognizes that the use of such personal information data, in the present technology, can be used to the benefit of users. For example, the personal information data can be used to automatically perform operations with respect to playing content in a particular format. Accordingly, use of such personal information data enables users to enter fewer inputs to perform an action with respect to such actions.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain of the user's content data when determining in which format to play content.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content data can be recognized based on aggregated non-personal information data or a bare minimum amount of personal information, such as the data being handled only on the user's device, or other non-personal information.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display generation component and one or more input devices:
while displaying, via the display generation component, a content playback user interface for a first content item that is playing at the electronic device, wherein the electronic device is playing the first content item in a first format:
in accordance with a determination that the first content item is available in a second format, different from the first format, and that a currently-active output device for playing the first content item is compatible with the second format, displaying, in the content playback user interface, a selectable option that is selectable to initiate a process to switch from playing the first content item in the first format to playing the first content item in the second format.

2. The method of claim 1, wherein:
in accordance with a determination that the playing of the first content item is a first playback of a content item that is available in the second format, the selectable option is displayed in a first manner, and
in accordance with a determination that the playing of the first content item is not a first playback of a content item that is available in the second format, the selectable option is displayed in a second manner, different from the first manner.

3. The method of claim 1, further comprising:
while displaying, via the display generation component, the content playback user interface for the first content item that is playing at the electronic device, in accordance with a determination that the currently-active output device for playing the first content item is not compatible with the second format, forgoing displaying the selectable option in the content playback user interface.

4. The method of claim 1, further comprising:
while displaying, via the display generation component, the content playback user interface for the first content item that is playing at the electronic device, in accordance with a determination that compatibility of the currently-active output device for playing the first content item with the second format is unknown, displaying, in the content playback user interface, a selectable option that is selectable to display a visual indication that the currently-active output device may not be compatible with the second format.

5. The method of claim 1, further comprising:
detecting, via the one or more input devices, selection of the selectable option; and
in response to detecting the selection of the selectable option, continuing playback of the first content item in the second format from a playback position at which the first content item was playing when the selection of the selectable option was detected.

6. The method of claim 1, wherein the currently-active output device is an external device with which the electronic device is in communication.

7. The method of claim 1, further comprising:
detecting, via the one or more input devices, selection of the selectable option; and
in response to detecting the selection of the selectable option, enabling a setting of an operating system of the electronic device that enables playback of content in the second format by the currently-active output device.

8. The method of claim 1, further comprising:
detecting, via the one or more input devices, selection of the selectable option; and
without detecting further input directed to the selectable option:
in response to detecting the selection of the selectable option, continuing playback of the first content item in the second format;
after playing the first content item, playing a second content item that is available in the first format and not available in the second format, wherein the electronic device is playing the second content item in the first format; and
after playing the second content item, playing a third content item that is available in the first format and the second format, wherein the electronic device is playing the third content item in the second format.

9. The method of claim 1, further comprising:
while playing the first content item in the second format via a first output device, detecting that the currently active output device has changed from the first output device to a second output device, wherein the second output device is not compatible with the second format; and
in response to detecting that the second output device is the currently-active output device, continuing playback of the first content item in the first format.

10. The method of claim 9, further comprising:
while playing the first content item in the first format via the second output device, detecting that the currently active output device has changed from the second output device to a third output device, wherein the third output device is compatible with the second format; and
in response to detecting that the third output device is the currently-active output device, continuing playback of the first content item in the second format.

11. The method of claim 1, further comprising:
displaying, via the display generation component, a content browsing user interface including a plurality of representations of content items available for playback at the electronic device, wherein:
in accordance with a determination that a respective content item is available in the second format, a respective representation of the respective content item in the content browsing user interface includes a visual indication that indicates the respective content item is available in the second format; and
in accordance with a determination that the respective content item is not available in the second format, the respective representation of the respective content item in the content browsing user interface does not include the visual indication.

12. The method of claim 1, further comprising:
detecting, via the one or more input devices, an input corresponding to a request to download, to the electronic device, a respective content item; and
in response to detecting the input:
in accordance with a determination that the respective content item is available in the second format and that the request to download the respective content item is a first request to download a content item available in the second format to the electronic device, displaying, via the display generation component, a confirmation user interface for confirming whether to download the respective content item in the first format or the second format.

13. The method of claim 1, further comprising:
while displaying, via the display generation component, a content playback user interface for a second content item that is playing at the electronic device, displaying, in the content playback user interface, a visual indication of a currently-playing format of the second content item, wherein:
in accordance with a determination that an output signal path including the currently-active output device is not capable of playing the second content item in the currently-playing format, the visual indication is displayed in a first manner, and
in accordance with a determination that the output signal path including the currently-active output device is capable of playing the second content item in the currently-playing format, the visual indication is displayed in a second manner, different from the first manner.

14. The method of claim 13, further comprising:
detecting, via the one or more input devise, selection of the visual indication; and
in response to detecting the selection of the visual indication, displaying, via the display generation component, a respective user interface associated with the currently-playing format of the second content item, wherein the respective user interface includes:
in accordance with a determination that the second content item is available in a respective format that is higher quality than the currently-playing format, information that indicates the second content item is available in the respective format, and a selectable option that is selectable to display a user interface from which access to the second content item in the respective format can be enabled.

15. The method of claim 13, further comprising:
detecting, via the one or more input devise, selection of the visual indication; and
in response to detecting the selection of the visual indication, displaying, via the display generation component, a respective user interface associated with the currently-playing format of the second content item, wherein the respective user interface includes:
in accordance with the determination that the output signal path including the currently-active output device is not capable of playing the second content item in the currently-playing format, information that indicates that the output signal path including the currently-active output device is not capable of playing the second content item in the currently-playing format, and a selectable option that is selectable to display a user interface from which access to the second content item in the currently-playing format can be disabled.

16. The method of claim 1, wherein content is available at the electronic device in the second format and a third format, and content cannot be played by the electronic device in the second format and the third format concurrently, the method further comprising:
while playing a respective content item that is available in the second format and the third format:
in accordance with a determination that a setting for prioritizing the second format over the third format is enabled, playing the respective content item in the second format; and
in accordance with a determination that the setting for prioritizing the second format over the third format is not enabled, playing the respective content item in the third format.

17. An electronic device, comprising:
one or more processors;
memory; and
one or more programs, wherein the one or more programs are stored in the memory and configured to be executed by the one or more processors, the one or more programs including instructions for:
while displaying, via a display generation component, a content playback user interface for a first content item that is playing at the electronic device, wherein the electronic device is playing the first content item in a first format:
in accordance with a determination that the first content item is available in a second format, different from the first format, and that a currently-active output device for playing the first content item is compatible with the second format, displaying, in the content playback user interface, a selectable option that is selectable to initiate a process to switch from playing the first content item in the first format to playing the first content item in the second format.

18. A non-transitory computer readable storage medium storing one or more programs, the one or more programs comprising instructions, which when executed by one or more processors of an electronic device, cause the electronic device to perform a method comprising:
while displaying, via a display generation component, a content playback user interface for a first content item that is playing at the electronic device, wherein the electronic device is playing the first content item in a first format:
in accordance with a determination that the first content item is available in a second format, different from the first format, and that a currently-active output device for playing the first content item is compatible with the second format, displaying, in the content playback user interface, a selectable option that is selectable to initiate a process to switch from playing the first content item in the first format to playing the first content item in the second format.

19-24. (canceled)
